(19) United States
(12) Patent Application Publication
(10) Pub. No.: US 2022/0403229 A1
(43) Pub. Date: Dec. 22, 2022

(54) ELECTRONIC CONTROL OF TRANSMITTANCE OF VISIBLE AND NEAR-INFRARED RADIATION

(71) Applicant: Kebotix, Inc., Cambridge, MA (US)

(72) Inventors: Dennis Sheberla, Bedford, MA (US); Selma Duhovic, Denver, CO (US); Sreeletha Joby Eldo, Andover, MA (US); Nathan Darrell Peterson Ricke, Medford, MA (US); Nicolas Yvan Masse, Cambridge, MA (US); Semion Saykin, Arlington, MA (US); Tanja Dimitrov, Brooklyn, NY (US)

(73) Assignee: Kebotix, Inc., Cambridge, MA (US)

(21) Appl. No.: 17/772,237

(22) PCT Filed: Oct. 27, 2020
(86) PCT No.: PCT/US2020/057498

§ 371 Date: Apr. 27, 2022

Related U.S. Application Data
(60) Provisional application No. 62/927,095, filed on Oct. 28, 2019.

(51) Int. Cl. C09K 9/02; G02F 1/1516; G02F 1/163; G02F 1/155

(52) U.S. Cl. CPC C09K 9/02; G02F 1/1516; G02F 1/163; G02F 1/155; C09K 2211/1018; C09K 2211/1007; G02F 2203/01

(57) ABSTRACT

The present invention generally relates to optoelectronic compounds, including certain nitrobenzoyl compounds, for example 2-(4-nitrobenzoyl)oxazole. In certain embodiments, these compounds can be used as electrochromic media in devices requiring change of optical absorbance or transmittance as a function of applied voltage. Examples of such devices include electrochromic mirrors, windows, displays, or the like. One specific example is solar and thermal control by smart, dynamic windows for energy-efficient buildings. Other embodiments of the invention are generally directed to systems and devices using such compounds, methods of using such compounds, e.g., to control the absorbance or transmittance of light, kits involving such compounds, or the like.

### RELATED APPLICATIONS

This application claims the benefit of U.S. Provisional Patent Application Ser. No. 62/927,095, filed Oct. 28, 2019, entitled “Electronic Control of Transmittance of Visible and Near-Infrared Radiation,” by Sheberla, et al., incorporated herein by reference in its entirety.

### FIELD

The present invention generally relates to optoelectronic compounds, including certain nitrobenzoyl compounds.

### BACKGROUND

Electrochromic materials are materials where the color or opacity of the material changes as a function of the voltage applied to it. For example, when a voltage is applied, an electrochromic material may change its transmittance to light, e.g., to visible, ultraviolet, or infrared light. Such materials may be used in a variety of applications. However, as many electrochromic materials exhibit only certain ranges of changes in variable transmittance, there remains a need for new types of electrochromic materials for various applications.

### SUMMARY

The present invention generally relates to optoelectronic compounds, including nitrobenzoyl compounds. The subject matter of the present disclosure involves, in some cases, interrelated products, alternative solutions to a particular problem, and/or a plurality of different uses of one or more systems and/or articles.

In one aspect, the present invention is generally directed to an electrochromic device. In accordance with one set of embodiments, the electrochromic device comprises an electrochromic region comprising a nitrobenzoyl compound; and a voltage source able to apply voltage to the electrochromic region.

The electrochromic device, in another set of embodiments, comprises a working electrode; a counter electrode; an electrochromic region comprising a nitrobenzoyl compound, positioned adjacent to the working electrode; and an electrolyte comprising an organic salt and a solvent, positioned adjacent to the electrochromic region.

In yet another set of embodiments, the electrochromic device comprises a working electrode, a counter electrode, a voltage source electrically connecting the working electrode and the counter electrode, an electrochromic region comprising a nitrobenzoyl compound, and an electrolyte comprising an organic salt and a solvent. The electrolyte, in some cases, may be positioned to cause ions from the organic salt to enter the electrochromic region when a voltage is applied by the voltage source.

In another aspect, the present invention is generally directed to a method. According to certain embodiments, the method comprises applying voltage to an electrochromic material comprising a nitrobenzoyl compound to cause the electrochromic material to exhibit a change in light transmittance.

In another aspect, the present invention encompasses methods of making one or more of the embodiments described herein, for example, various electrochromic materials or optoelectronic compounds. In still another aspect, the present invention encompasses methods of using one or more of the embodiments described herein, for example, various electrochromic materials or optoelectronic compounds.

Other advantages and novel features of the present invention will become apparent from the following detailed description of various non-limiting embodiments of the invention when considered in conjunction with the accompanying figures.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 illustrates an electrochromic device in accordance with one embodiment of the invention;

FIG. 2 illustrates a spectroscopic profile of 2-(4-nitrobenzoyl)oxazole, in accordance with another embodiment of the invention;

FIG. 3 illustrates a cyclic voltammetry graph of 2-(4-nitrobenzoyl)oxazole, in still another embodiment of the invention;

FIG. 4 illustrates a reaction scheme to produce a nitrobenzoyl compound, in accordance with yet another embodiment of the invention;

FIGS. 5A-5B illustrate reaction schemes to produce nitrobenzoyl compounds, in still other embodiments of the invention; and

FIGS. 6-35 illustrate certain additional optoelectronic compounds, in accordance with yet other embodiments of the invention.

### DETAILED DESCRIPTION

The present invention generally relates to optoelectronic compounds, including certain nitrobenzoyl compounds, for example 2-(4-nitrobenzoyl)oxazole. In certain embodiments, these compounds can be used as electrochromic media in devices requiring change of optical absorbance or transmittance as a function of applied voltage. Examples of such devices include electrochromic mirrors, windows, displays, or the like. One specific example is solar and thermal control by smart, dynamic windows for energy-efficient buildings. Other embodiments of the invention are generally directed to systems and devices using such compounds, methods of using such compounds, e.g., to control the absorbance or transmittance of light, kits involving such compounds, or the like.

One aspect is generally directed to systems and methods of electrically controlling the absorbance or transmittance of light. For example, in some cases, certain types of nitrobenzoyl compounds are used that can function as optoelectronic compounds. Such optoelectronic compounds can be used in electrochromic media, where the amount of light absorbance or transmittance is controllable by applying voltages. For example, the optoelectronic compound may exhibit a first light transmittance at a first voltage (e.g., including 0 V), and a second light transmittance at a second voltage different from the first. In some cases, a variety of different voltages can be applied to control the light absorbance or transmittance of the electrochromic media.

Certain embodiments are generally directed to nitrobenzoyl compounds. Nitrobenzoyl compounds have not generally been identified as being suitable optoelectronic compounds, e.g., for use within electrochromic media. However, it has been found that certain types of nitrobenzoyl compounds are able to absorb a variable amount of visible light (e.g., wavelengths of 400-700 nm) and/or near-infrared light (e.g., wavelengths of 700-2500 nm) light in response to applied voltages.

One non-limiting example of a nitrobenzoyl compound is 2-(4-nitrobenzoyl)oxazole, which has a formula C₁₀H₆N₂O₄, and a structure:

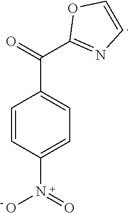

Other examples of nitrobenzoyls include those having a structure:

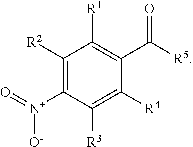

In the above structure, the functional groups R¹, R², R³, and R⁴ may each independently be —H, or be selected from groups such as an alkyl group (a methyl group, an ethyl group, a propyl group an isopropyl group, a n-butyl group, a t-butyl group, a pentyl group, a hexyl group, an octyl group, a dodecyl group, etc.), a cycloalkyl group (such as a cyclopropyl group, a cyclopentyl group, a cyclohexyl group, a cyclooctyl group, etc.).

In addition, in the above example, the functional group R⁵ may be selected from a group such as an alkenyl group (such as vinyl group, a propenyl group, an allyl group, etc.), an alkynyl group (such as an acetylene group, a propargyl group, an octynyl group, or the like), an aryl group (such as a phenyl group, a naphthyl group, a p-tolyl group, etc.) an alkoxy group (such as a methoxy group, an ethoxy group or a propoxy group, or the like), a heterocyclic group (such as an epoxy group, a furyl group, a pyrrolyl group, a thiazolyl group, an oxazolyl group, an imidazolyl group, a triazyl group, a pyridyl group, a pyrazinyl group, etc.), or the like.

Without wishing to be bound by any theory, it is believed that substitutions such as these will not significantly affect the electrochromic properties of the nitrobenzoyl structure so as to prevent such structures from being electrochromic, and those of ordinary skill in the art will be able to readily substitute such structures in the synthesis of such nitrobenzoyl structures.

Thus, as non-limiting examples of nitrobenzoyl substitutions that would not affect the electrochromic properties of the molecules, in some cases, the nitrobenzoyl may be a nitrobenzoyloxazole, or a nitrobenzoylthiazole. For instance, R⁵ may be an alkyl, an alkenyl (e.g., —CH═CH₂), or have a structure such as:

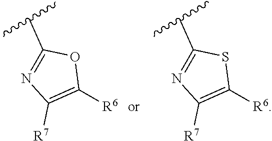

As yet another example R⁵ may have a structure:

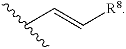

In the above structures, R⁶, R⁷, and R⁸ may each independently be —H, or a functional group such as those described above. Thus, for example, R⁶, R⁷, and R⁸ may each independently be selected from an alkyl group (methyl, ethyl, propyl, etc.), a cycloalkyl group (such as a cyclopropyl group, a cyclopentyl group, a cyclohexyl group, a cyclooctyl group, etc.), an alkenyl group (such as a vinyl group, a propenyl group, an allyl group, etc.), an alkynyl group (such as an acetylene group, a propargyl group, an octynyl group, or the like), an aryl group (such as a phenyl group, a naphthyl group, a p-tolyl group, etc.) an alkoxy group (such as a methoxy group, an ethoxy group, a propoxy group, or the like), a heterocyclic group (such as an epoxide group, a furyl group, a pyrrolyl group, a thiazolyl group, an oxazolyl group, an imidazolyl group, a pyridyl group, a pyrazinyl group, a pyrimidinyl group, a piperidinyl group, a pyrazolyl group, etc.), an alkoxy carbonyl group (such as a methoxy carbonyl group, an ethoxy carbonyl group, etc.), an alkyl sulfonyl group (such as a methyl sulfonyl group, an ethyl sulfonyl group, a p-tolyl sulfonyl group, a cyclohexyl sulfonyl group, etc.), an amino group, an alkyl amino group (such as methyl amino group, ethyl amino group, propyl amino group, phenyl amino group, etc.), a nitro group, a nitrile group, an amide group, a carboxylic acid group, a hydroxy group, a halogen atom (for example, F, Cl, Br or I), a trifluoro methyl group, a trichloromethyl group, a tribromomethyl group, an acyl group, or the like.

As another example, in one embodiment, one or more of R⁶, R⁷, and R⁸ is an amide (for example, —CONH₂). In another embodiment, one or more of R⁶, R⁷, and R⁸ is an ester (e.g., —COCH₃ or —COCH₂CH₃, etc.). In yet another embodiment, one or more of R⁶, R⁷, and R⁸ is an alkyl (e.g., —CH₃, —CH₂CH₃, etc.). As a non-limiting example, R⁶ may be —CONH₂, —COCH₃, or —CH₃ when R⁷ is —H. As another example, R⁷ may be —CONH₂, —COCH₃, or —CH₃ when R⁶ is —H. In addition, in some embodiments, as previously discussed, one or more of R¹, R², R³, and R⁴ in the nitrobenzoyloxazole or the nitrobenzoylthiazole may each independently be —H, or one of the functional groups described herein.

In addition, in one set of embodiments, each of R¹, R², R³, and R⁴ in the nitrobenzoyl compound is —H. Thus, the nitrobenzoyl, in certain embodiments, may have a structure:

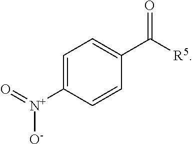

where R⁵ may have any of the structures described above. For instance, R⁵ may be an oxazole, or be selected from an alkenyl group (such as vinyl group, a propenyl group, an allyl group, etc.), an alkynyl group (such as an acetylene group, a propargyl group, an octynyl group, or the like), an aryl group (such as a phenyl group, a naphthyl group, a p-tolyl group, etc.) a heterocyclic group (such as an epoxy group, a furyl group, a pyrrolyl group, a thiazolyl group, an oxazolyl group, an imidazolyl group, a triazyl group, a pyridyl group, a pyrazinyl group, etc.), or the like.

In any of the above structures, an alkyl group, alkenyl group, an aryl group, a carbocyclic group or a heterocyclic group represented by R¹, R², R³, R⁴, R⁵, R⁶, R⁷, or R⁸ may further have substituents including an alkoxy group (such as a methoxy group, an ethoxy group or a propoxy group, or the like), a heterocyclic group (such as an epoxide group, a furyl group, a pyrrolyl group, a thiazolyl group, an oxazolyl group, an imidazolyl group, a triazyl group, a pyridyl group, a pyrazinyl group, a pyrimidinyl group, a piperidinyl group, pyrazolyl group, a morpholino group, etc.), an alkoxy carbonyl group (such as a methoxy carbonyl group, an ethoxy carbonyl group, etc.), an alkyl sulfonyl group (such as a methyl sulfonyl group, an ethyl sulfonyl group, a p-tolyl sulfonyl group, a cyclohexyl sulfonyl group, etc.), an amino group, an alkyl amino group (such as a methyl amino group, an ethyl amino group, a propyl amino group, a phenyl amino group, etc.), a nitro group, a nitrile group, an isonitrile group, a thiol group, an amide group, a carboxylic acid group, a hydroxy group, an epoxide group, an aziridine group, a halogen atom (including F, Cl, Br or I), a trifluoro methyl group, a trichloromethyl group, a tribromomethyl group or the like.

Specific examples of nitrobenzoyloxazoles include, but are not limited to:

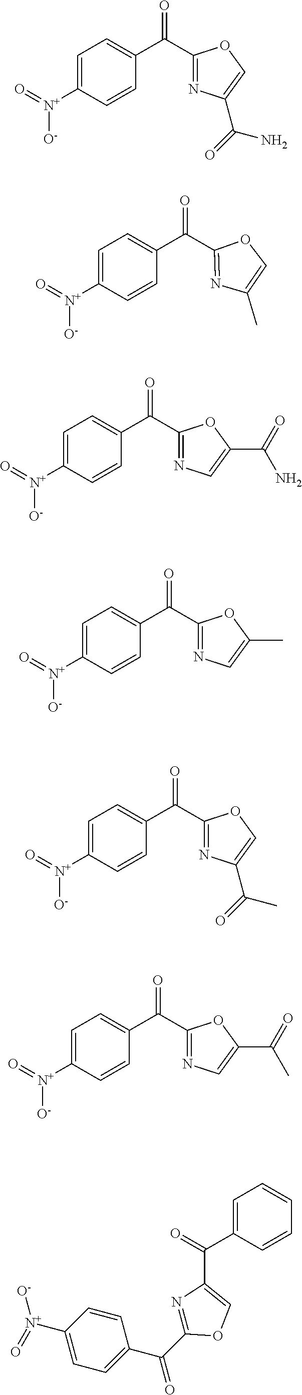

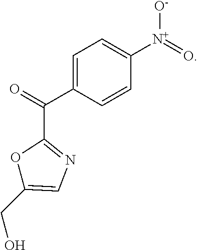 [SMILES: O=C(c1ccc([N+](=O)[O-])cc1)c1ncc(CO)o1]

In addition, other nitrobenzoyl compounds are also possible in other embodiments of the invention. Thus, the invention is not limited to only nitrobenzoyloxazoles. For instance, specific non-limiting examples of other nitrobenzoyl compounds include:

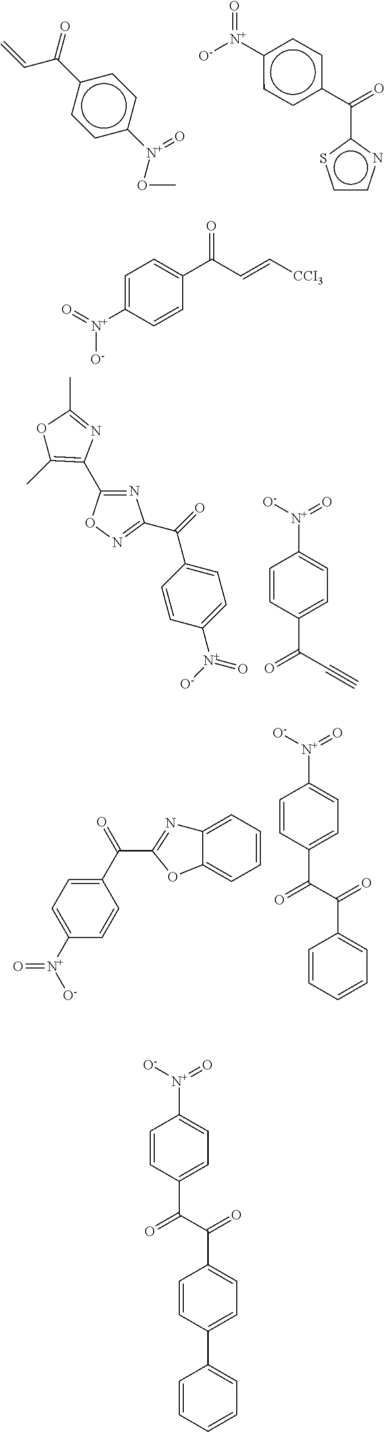

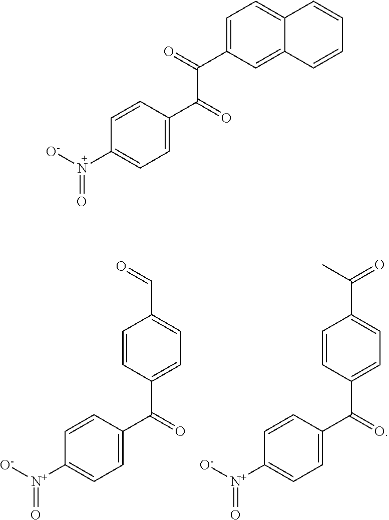

In one set of embodiments, the nitrobenzoyl may be heterocyclically substituted. As one non-limiting example, the heterocyclically substituted nitrobenzoyl may have a structure:

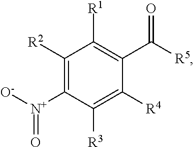

where R¹, R², R³, and R⁴ may each independently be —H or a functional group such as those described herein. For instance, the functional group may be an alkyl group such as methyl, ethyl, butyl, propyl, etc., a cycloalkyl group (for example, a cyclopropyl group, a cyclobutyl group, a cyclopentyl group, a cyclohexyl group, a cycloheptyl group, a cyclooctyl group, etc.), an aryl group, a vinyl group, an alkenyl group, an alkynyl group such as an acetylene or a heterocyclic group (e.g., epoxides, furans, thiophenes, imidazoles, pyrazoles, pyridines, pyrazines, etc.), an amine, an amide, a carboxylic group, an ester, an alcohol, an alkoxy group, an aryl group, a substituted phenyl group, etc. (e.g., attached through a carbonyl such as benzoyl), or a halogen such as F, Cl, Br, I, etc. R⁵ may comprise a 5-member aromatic ring having 1, 2, 3, or more heteroatoms, such as N, S, or O. Examples of R⁵ include, but are not limited to, the following structures:

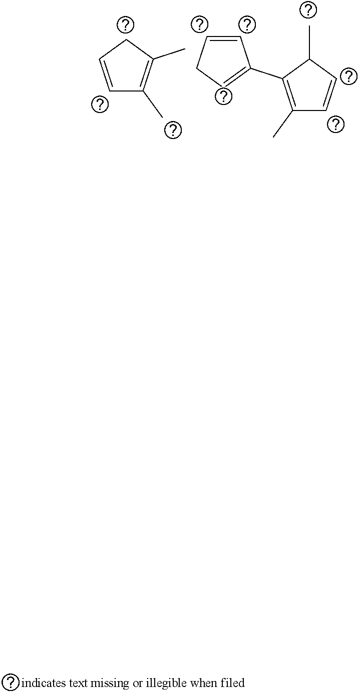

In the above structures, X and Y may each independently be —H or a functional group such as those described herein. For instance, the functional group may be an alkyl group such as methyl, ethyl, butyl, propyl, etc., a cycloalkyl group (for example, a cyclopropyl group, a cyclobutyl group, a cyclopentyl group, a cyclohexyl group, a cycloheptyl group, a cyclooctyl group, etc.), an aryl group, a vinyl group, an alkenyl group, an alkynyl group such as an acetylene or a heterocyclic group (e.g., epoxides, furans, thiophenes, imidazoles, pyrazoles, pyridines, pyrazines, etc.), an amine, an amide, a carboxylic group, an ester, an alcohol, an alkoxy group, an aryl group, a substituted phenyl group, etc. (e.g., attached through a carbonyl such as benzoyl), or a halogen such as F, Cl, Br, I, etc.

For instance, one non-limiting example of such a heterocyclically substituted nitrobenzoyl includes the following general structure:

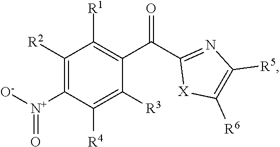

where X can be NH, N-alkyl, N-aryl, O or S, and R¹, R², R³, R⁴, R⁵ and R⁶ may each independently be —H or a functional group such as those described herein. For instance, the functional group may be an alkyl group such as methyl, ethyl, butyl, propyl, etc., a cycloalkyl group (for example, a cyclopropyl group, a cyclobutyl group, a cyclopentyl group, a cyclohexyl group, a cycloheptyl group, a cyclooctyl group, etc.), an aryl group, a vinyl group, an alkenyl group, an alkynyl group such as an acetylene or a heterocyclic group (e.g., epoxides, furans, thiophenes, imidazoles, pyrazoles, pyridines, pyrazines, etc.), an amine, an amide, a carboxylic group, an ester, an alcohol, an alkoxy group, an aryl group, a substituted phenyl group, etc. (e.g., attached through a carbonyl such as benzoyl), or a halogen such as F, Cl, Br, I, etc.

As another example, the heterocyclically substituted nitrobenzoyl may have a structures such as:

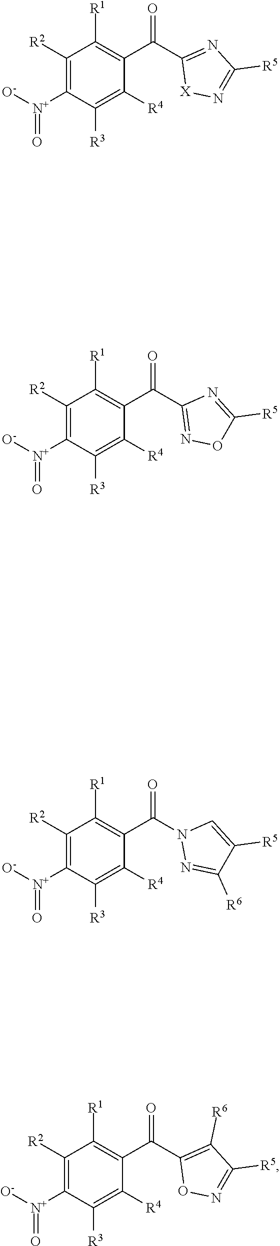

where X can be NH, N-alkyl, N-aryl, O, or S. R¹, R², R³, R⁴, R⁵ and R⁶ may each independently be —H or a functional group such as those described herein. For instance, the functional group may be an alkyl group such as methyl, ethyl, butyl, propyl, etc., a cycloalkyl group (for example, a cyclopropyl group, a cyclobutyl group, a cyclopentyl group, a cyclohexyl group, a cycloheptyl group, a cyclooctyl group, etc.), an aryl group, a vinyl group, an alkenyl group, an alkynyl group such as an acetylene or a heterocyclic group (e.g., epoxides, furans, thiophenes, imidazoles, pyrazoles, pyridines, pyrazines, etc.), an amine, an amide, a carboxylic group, an ester, an alcohol, an alkoxy group, an aryl group, a substituted phenyl group, etc. (e.g., attached through a carbonyl such as benzoyl), or a halogen such as F, Cl, Br, I, etc. In addition, in some cases, R⁵ and/or R⁶ may have heterocyclic structures, such as the following, or other 5-member heterosubstituted rings such as any of those described herein:

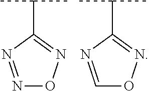

As another example, the heterocyclically substituted nitrobenzoyl may have a structures such as the following:

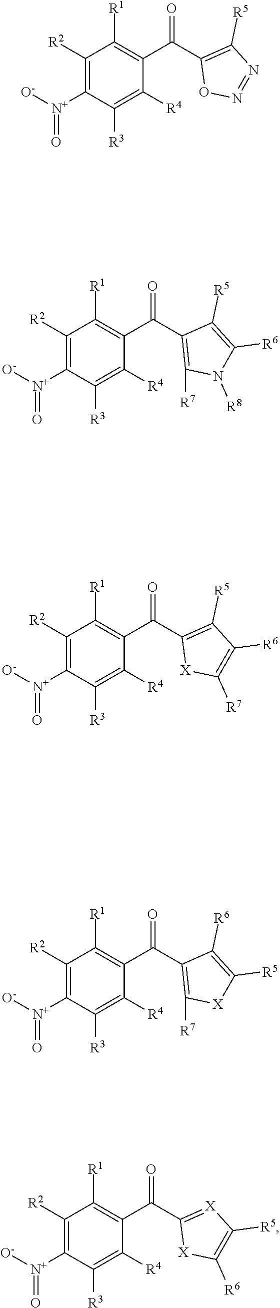

where each X can independently be NH, N-alkyl, N-aryl, O, or S. R¹, R², R³, R⁴, R⁵, R⁶, R⁷, and R⁸ may each independently be —H or a functional group such as those described herein. In some embodiments, both of the X's are not both O or both S. For instance, the functional group may be an alkyl group such as methyl, ethyl, butyl, propyl, etc., a cycloalkyl group (for example, a cyclopropyl group, a cyclobutyl group, a cyclopentyl group, a cyclohexyl group, a cycloheptyl group, a cyclooctyl group, etc.), an aryl group, a vinyl group, an alkenyl group, an alkynyl group such as an acetylene or a heterocyclic group (e.g., epoxides, furans, thiophenes, imidazoles, pyrazoles, pyridines, pyrazines, etc.), an amine, an amide, a carboxylic group, an ester, an alcohol, an alkoxy group, an aryl group, a substituted phenyl group, etc. (e.g., attached through a carbonyl such as benzoyl), or a halogen such as F, Cl, Br, I, etc.

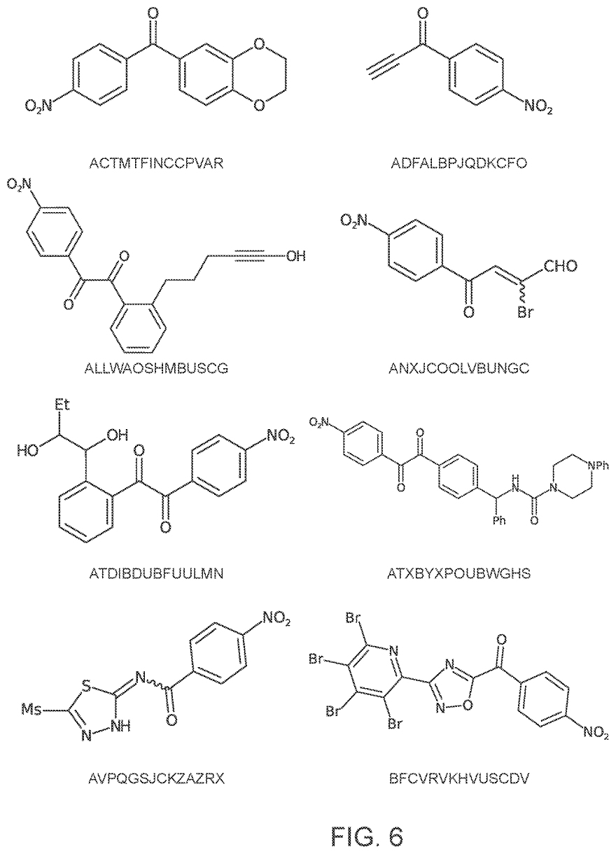

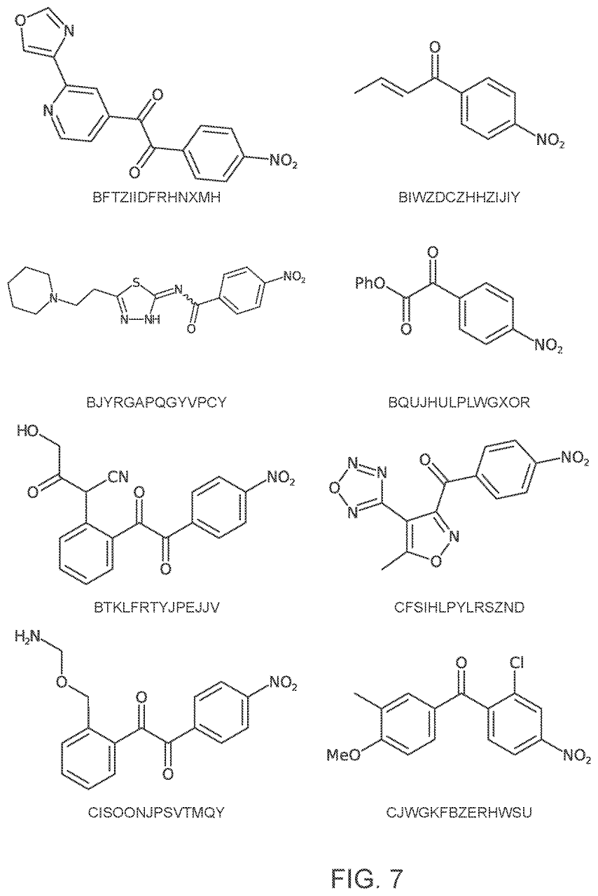

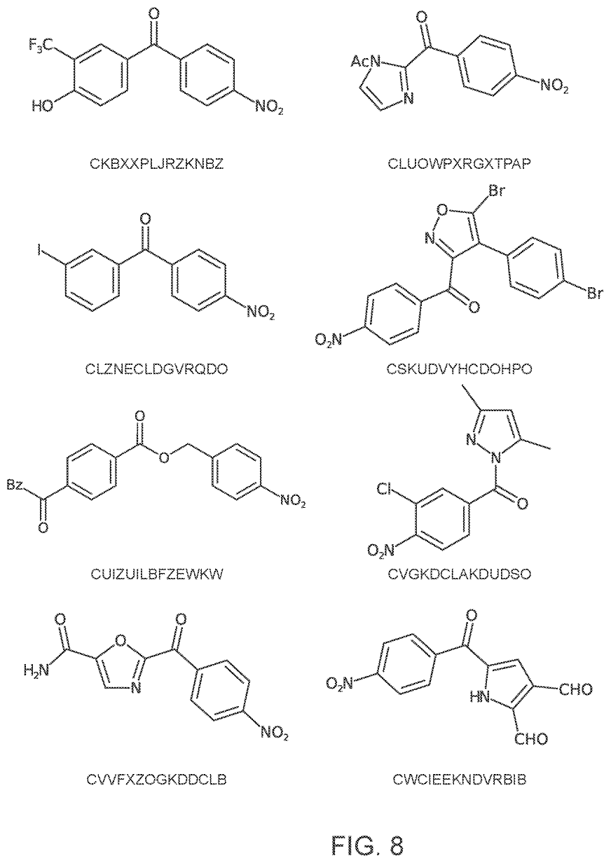

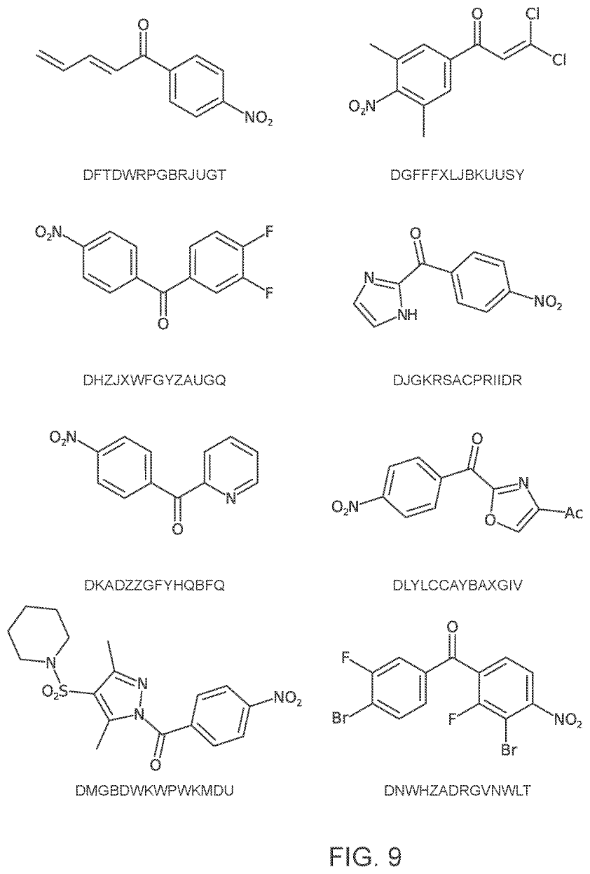

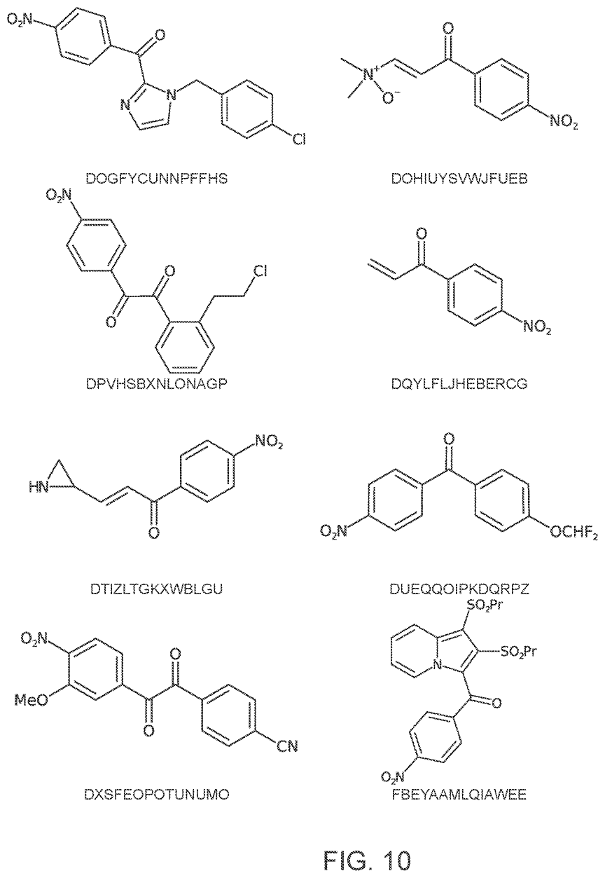

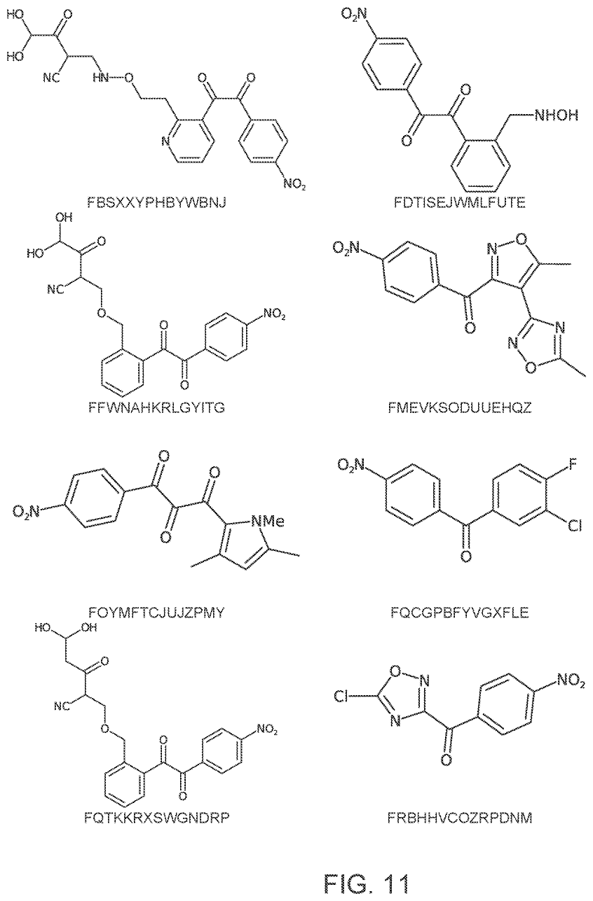

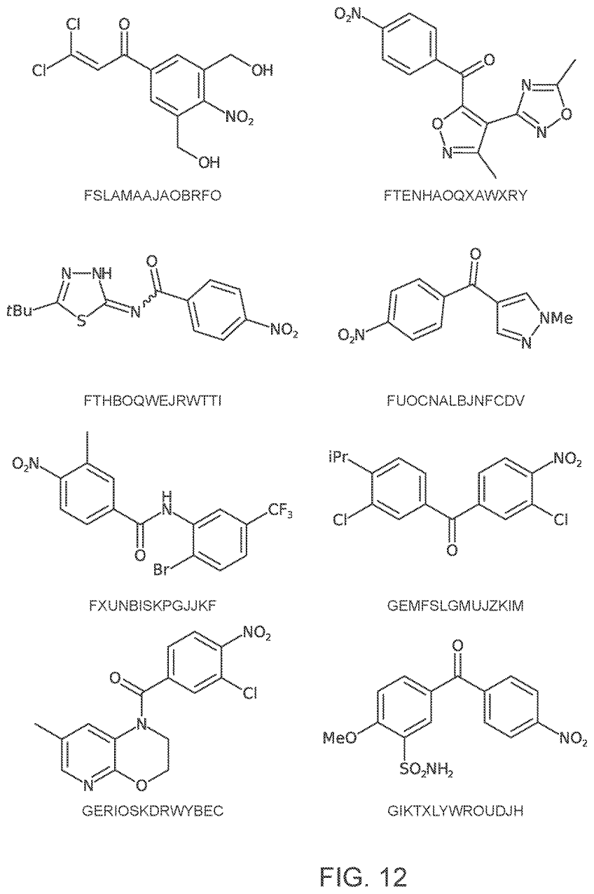

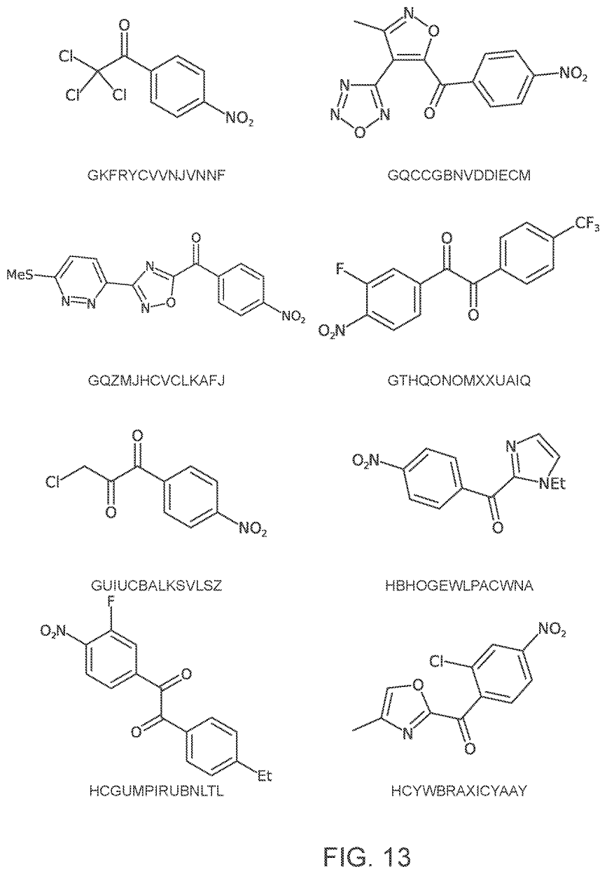

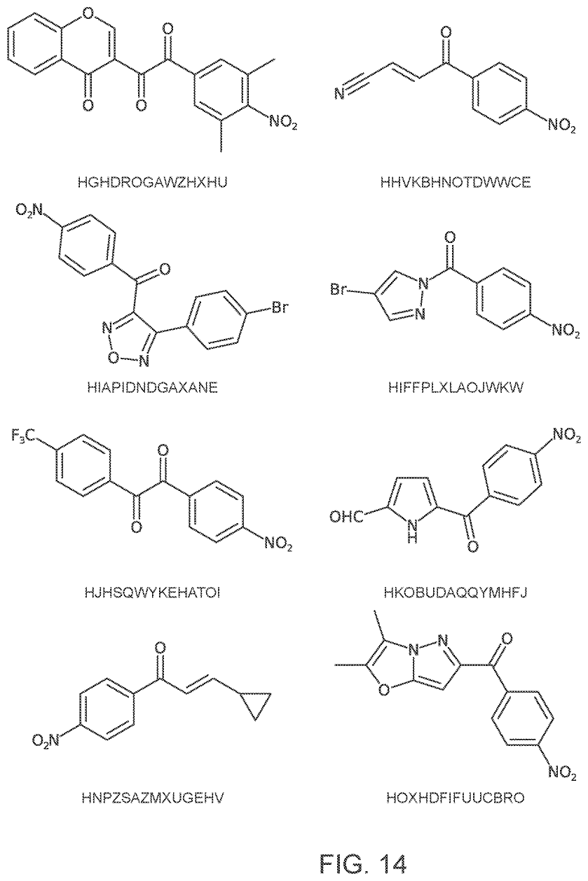

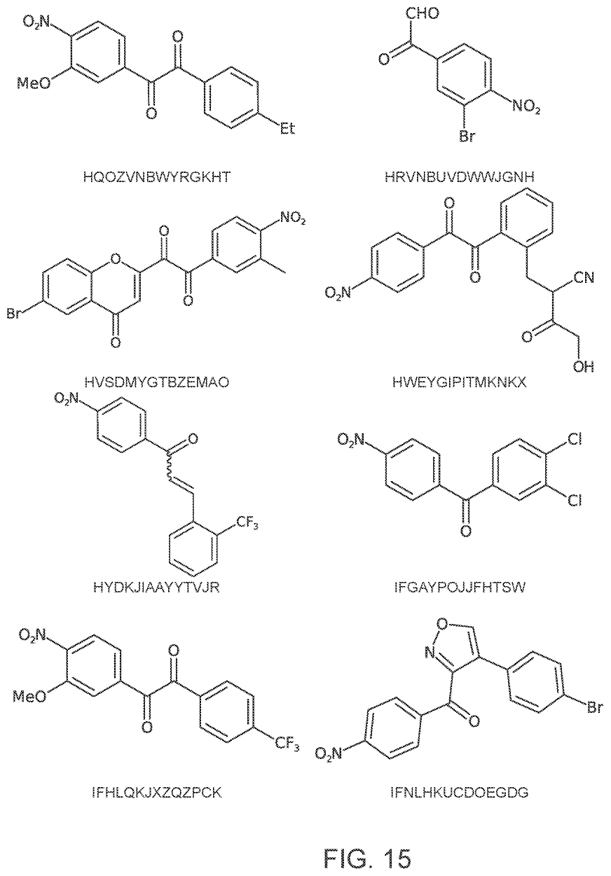

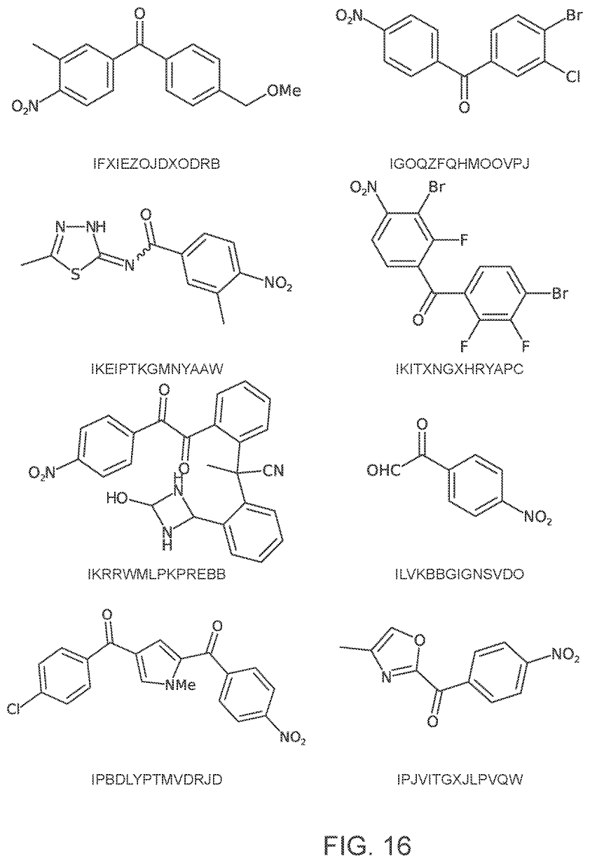

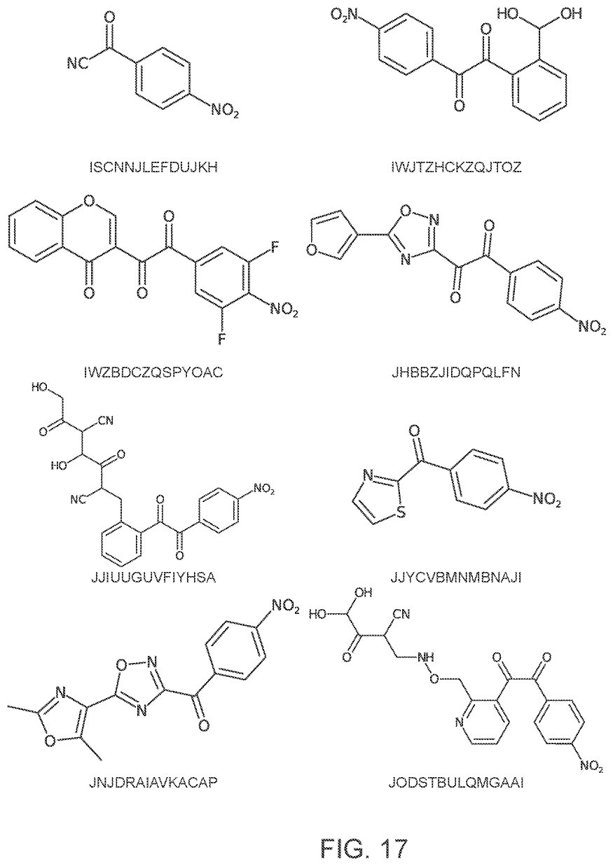

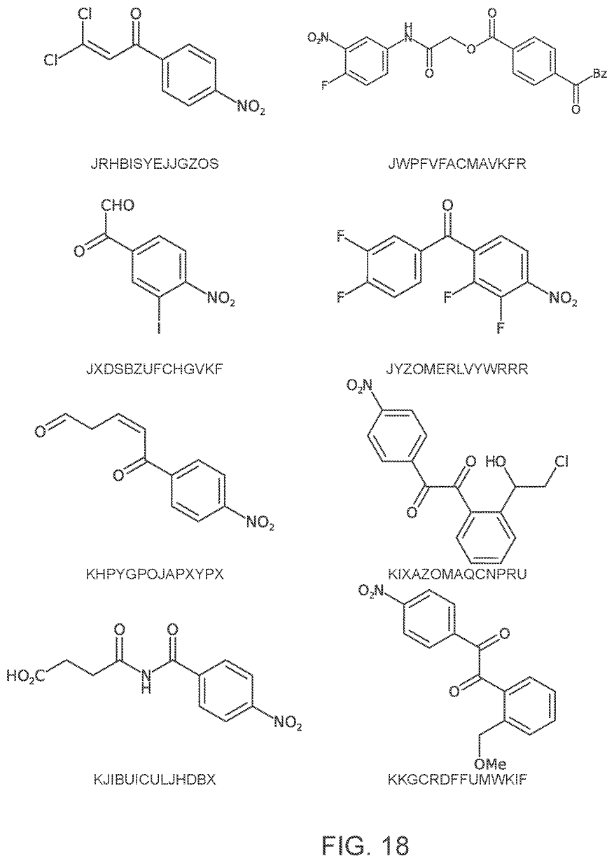

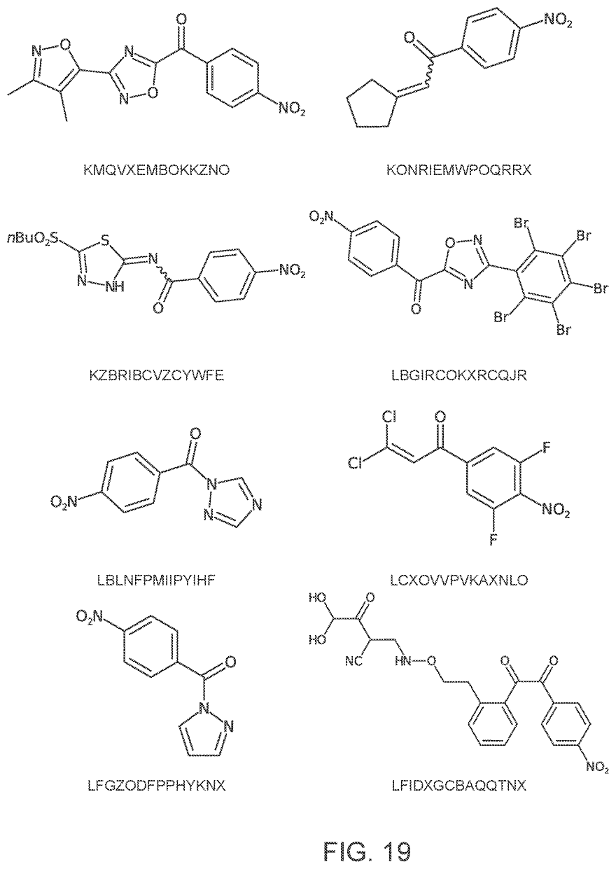

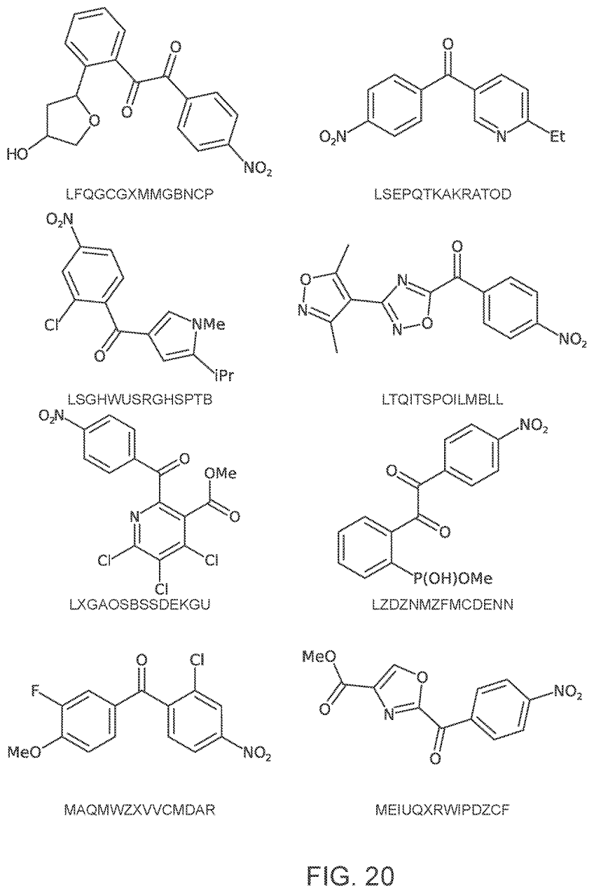

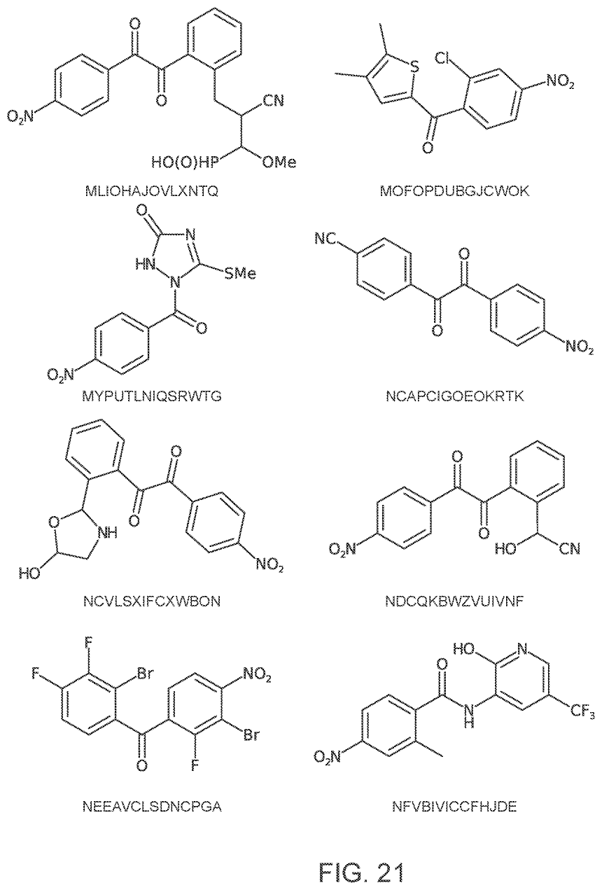

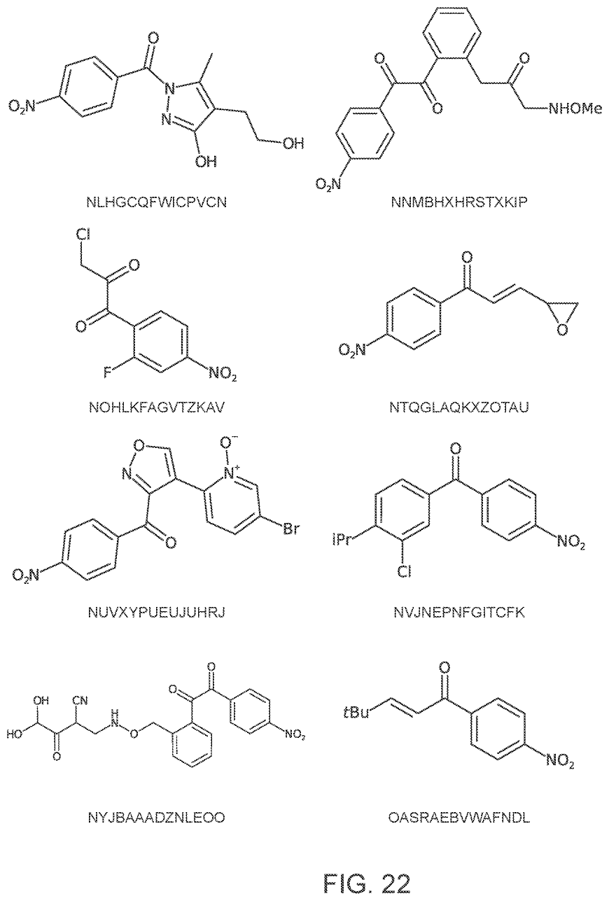

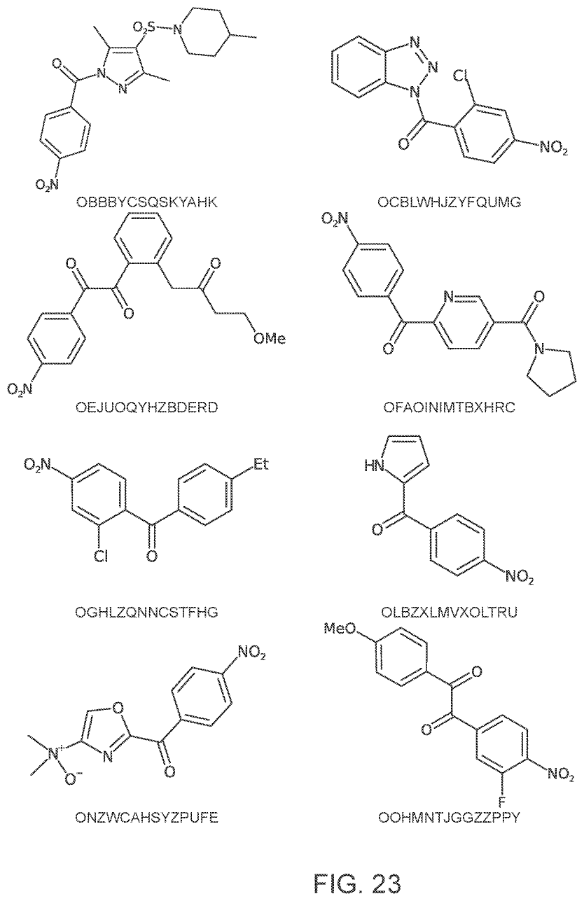

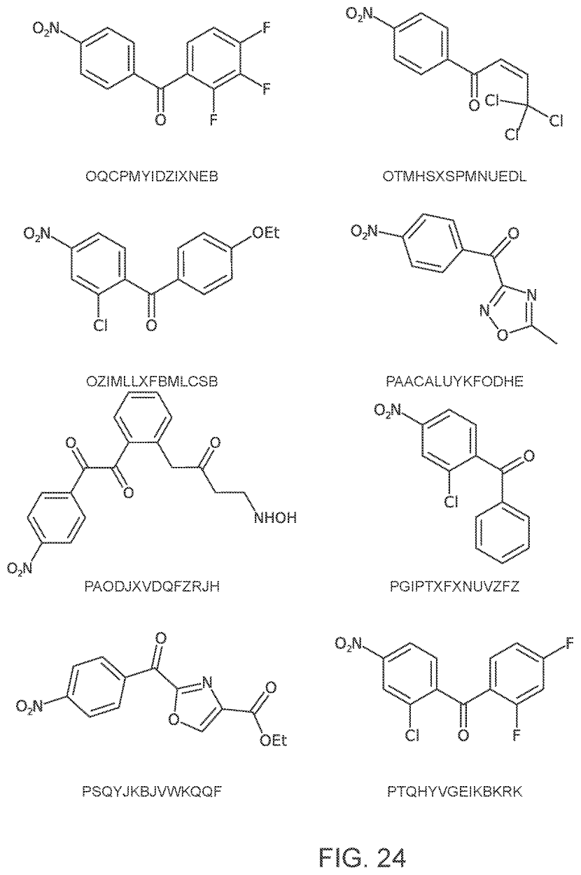

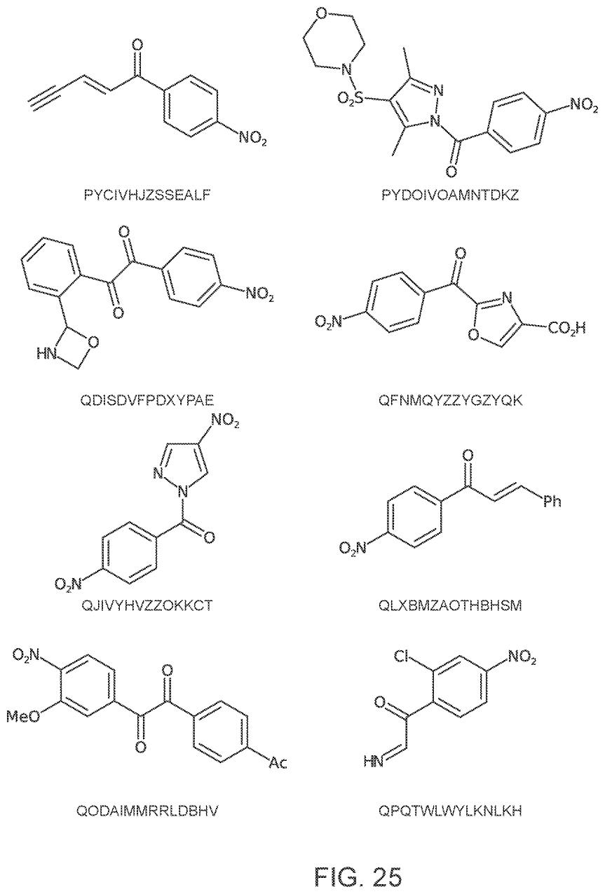

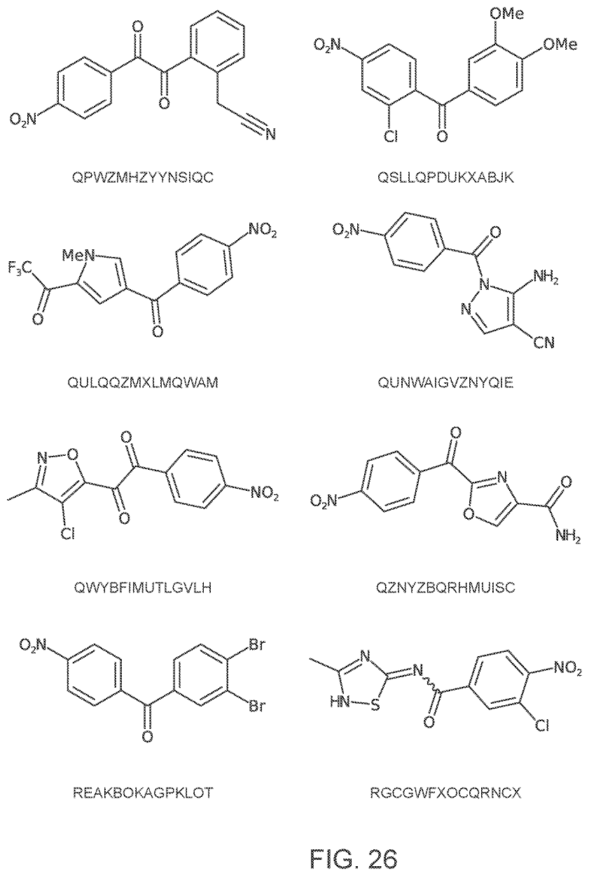

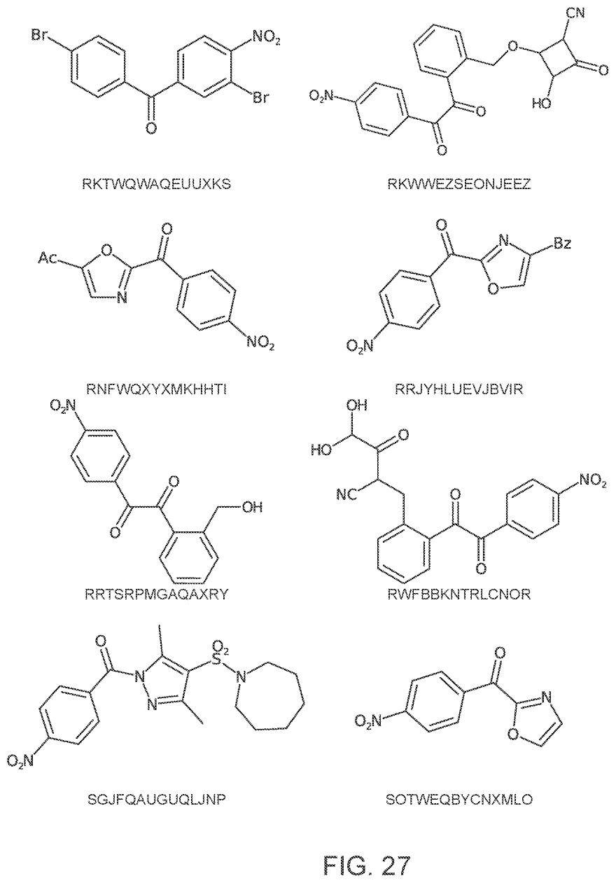

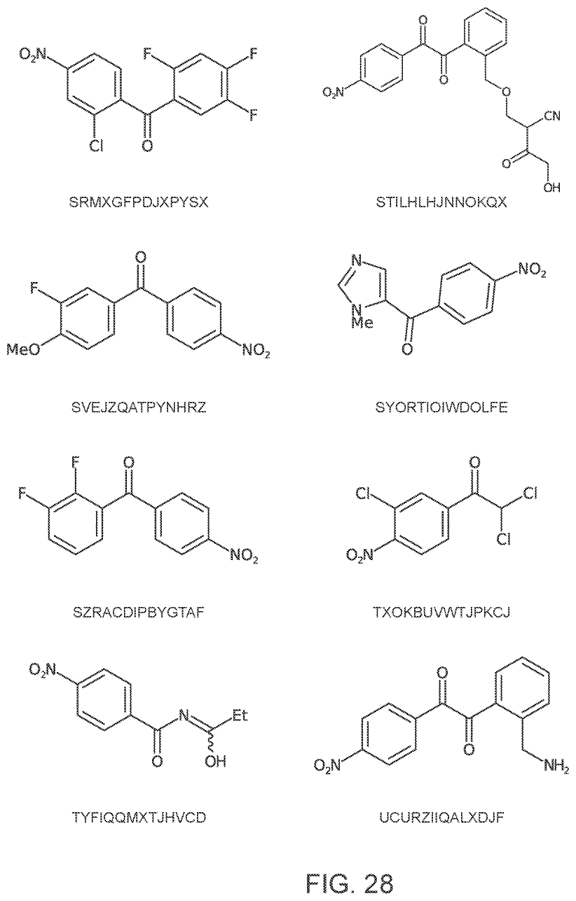

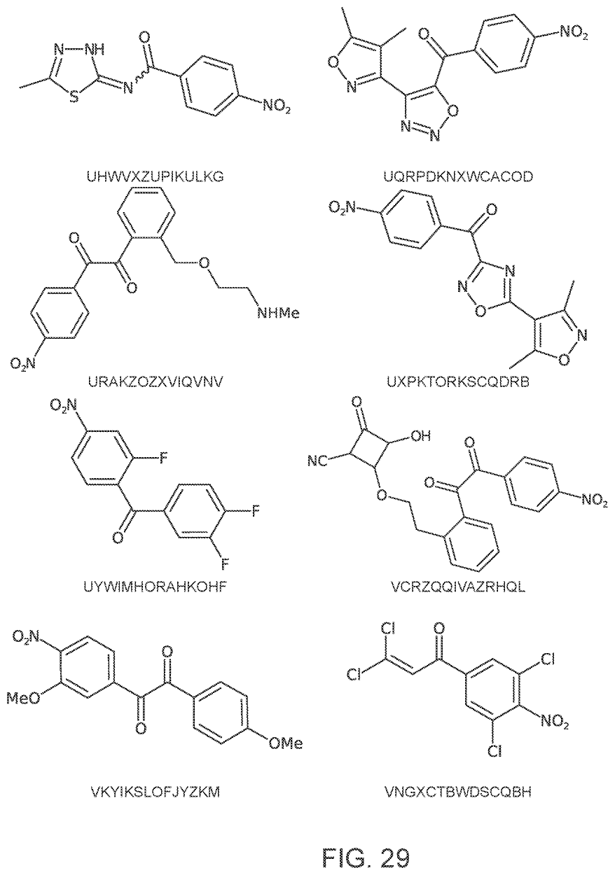

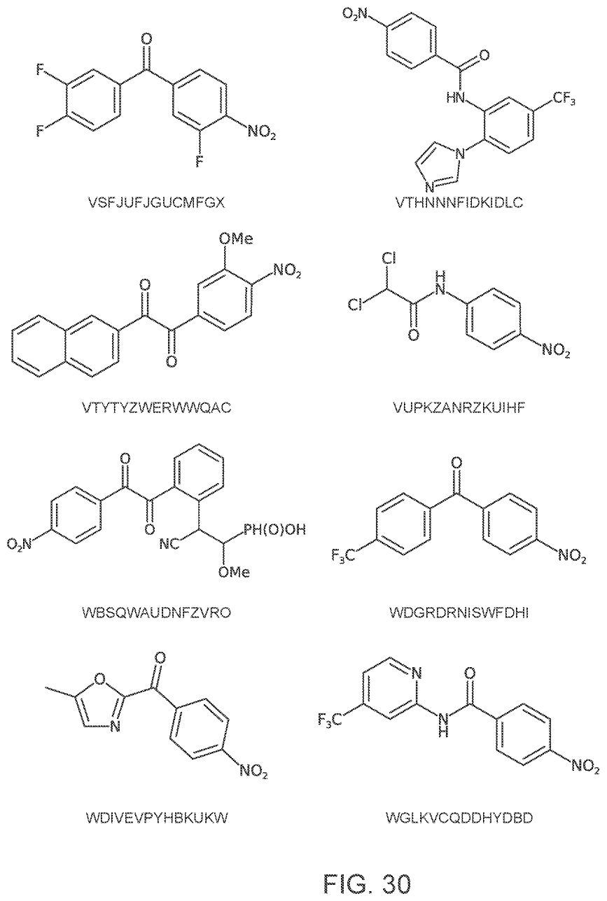

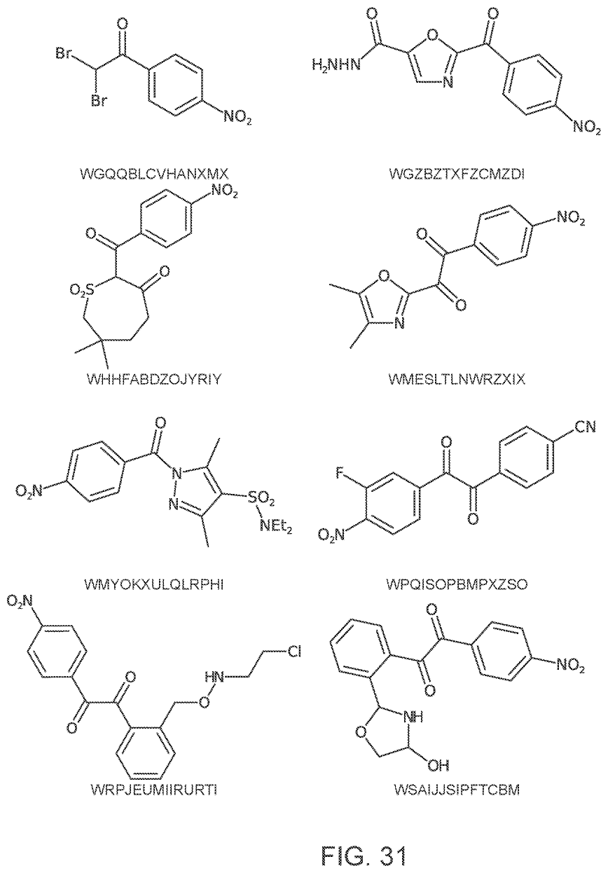

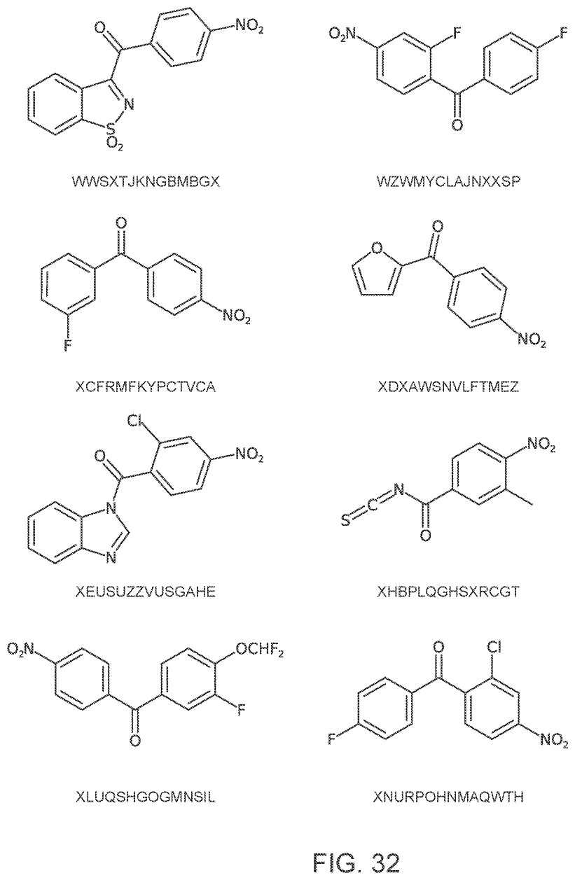

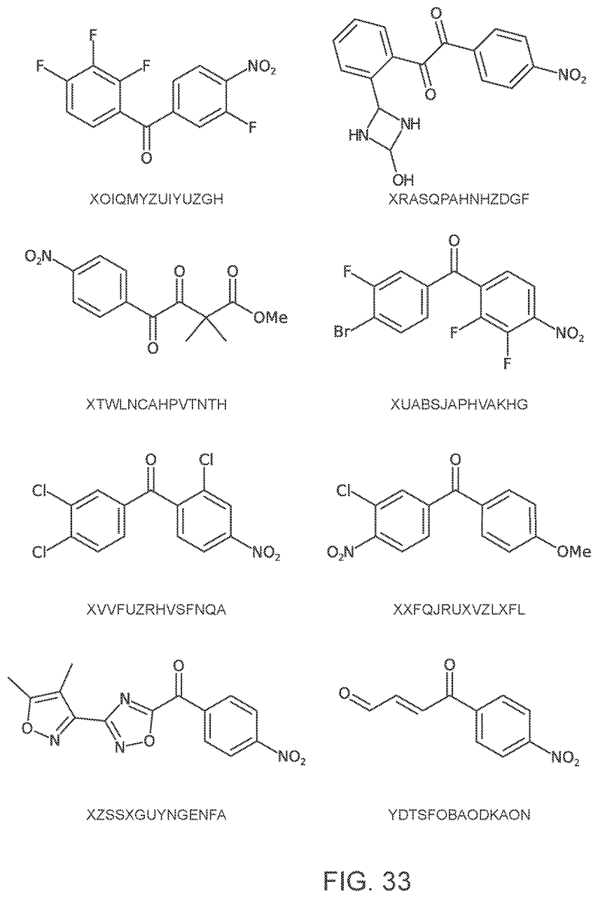

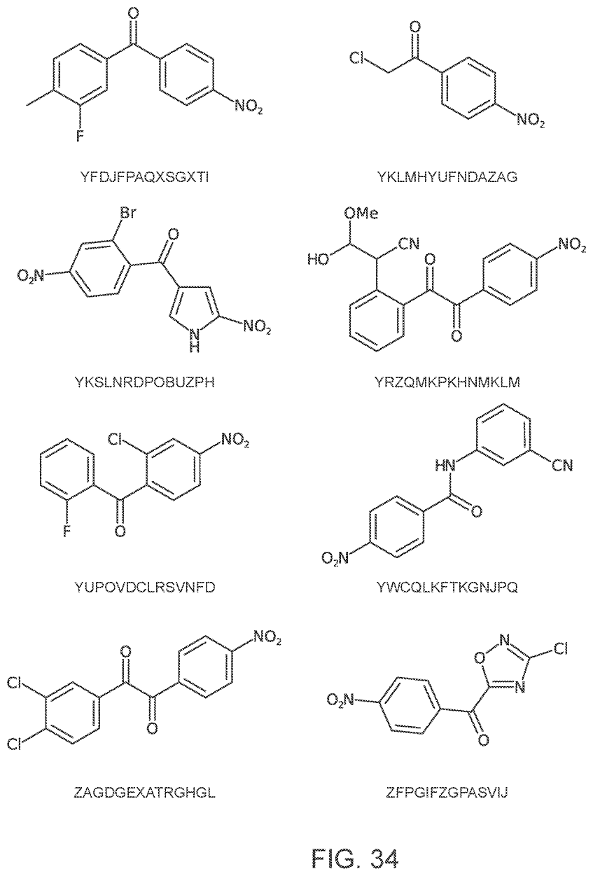

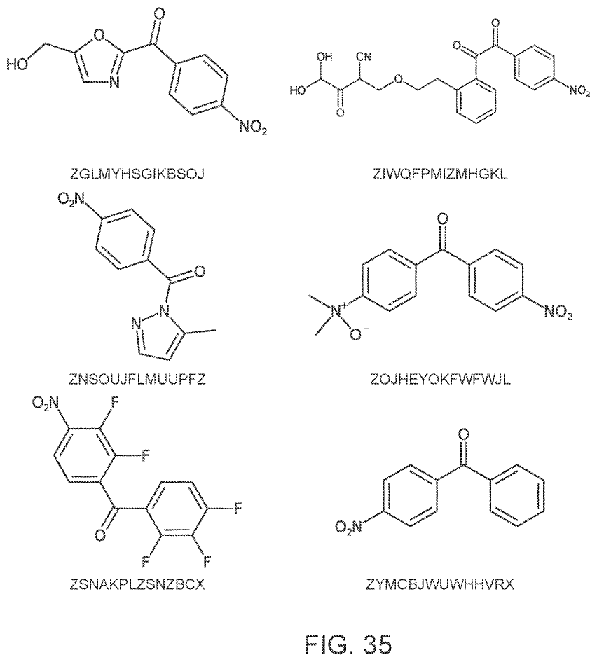

Still other non-limiting examples of potentially suitable optoelectronic compounds, including various nitrobenzoyls, nitrobenzoyloxazoles, etc., are shown in FIGS. 6-35. Each structure is identified by the first hash block (14 characters) of the InChIKey (International Chemical Identifier Key) of the compound's molecular structure (i.e., its connectivity information). Those of ordinary skill in the art will be familiar with the InChI system and its related InChIKey hashes.

Certain nitrobenzoyl compounds may, in some cases, be obtained commercially, or they may be synthesized, e.g., as discussed herein.

In some cases, the nitrobenzoyl compound may exhibit a decrease in overall light transmittance of at least 20% when a voltage is applied (and a corresponding increase in visible light absorption). In some cases, this decrease may be observed in the visible (between 400 and 700 nm), and/or in the near infrared (between 700 nm and about 2500 nm) region of the electromagnetic spectrum. Some certain light frequencies may exhibit even a greater decrease in light transmittance (or increase in light absorption), e.g., a change of at least 30%, at least 40%, at least 50%, at least 60%, at least 70%, etc. e.g., at a frequency of 750 nm, 800 nm, 850 nm, etc.

In some cases, the voltage applied to the nitrobenzoyl compound to cause such changes in light absorbance or transmittance may be at least −2 V, at least −1.5 V, at least −1 V, at least −0.5 V, at least −0.3 V, etc. versus a ferrocene/ferrocenium couple.

As an example, the spectroscopic profile of 2-(4-nitrobenzoyl)oxazole is shown in FIG. 2, showing the transmittance of light before and after applying an electrical potential. Other nitrobenzoyl compounds may exhibit similar spectroscopic profiles. For instance, 2-(4-nitrobenzoyl)oxazole exhibits a near-total transmittance of light in the range of 350 nm to 1100 nm (including visible and near infra-red light) when in neutral form. In other cases, the nitrobenzoyl compound may absorb at least 20%, at least 25%, at least 30%, at least 35%, at least 40%, at least 45%, at least 50%, at least 55%, at least 60%, or at least 65% of light in the range of 650 nm and 1100 nm when a negative voltage is applied, e.g., voltages such as are described herein. In some cases, the nitrobenzoyl compound is able to absorb incident light between 650 nm and 1100 nm.

Without wishing to be bound by any theory, it is believed that such nitrobenzoyl compounds exhibit electrochromic properties when an electron is added and ions, such as tetrabutylammonium, are transported to and/or from the nitrobenzoyl compounds, e.g., due to changes in voltage.

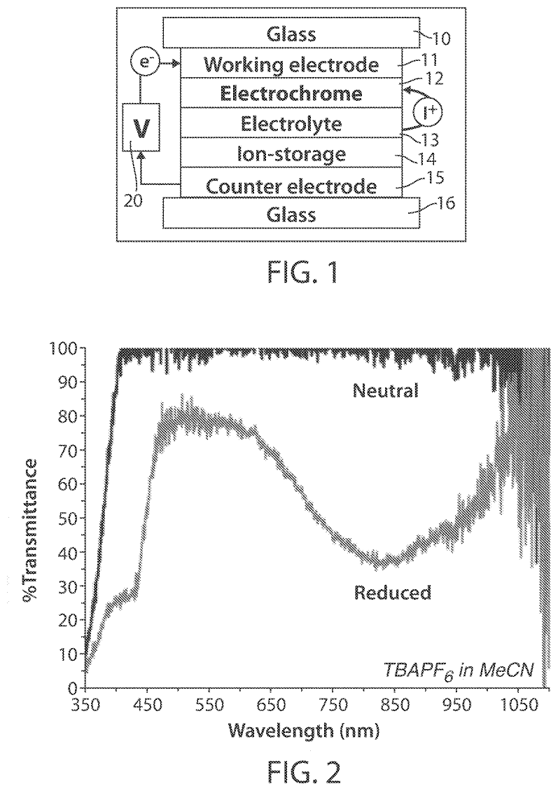

In some aspects, such nitrobenzoyl compounds may be contained within an electrochromic device. Examples of such devices include, but are not limited to, electrochromic mirrors, solar control windows, display devices, as well as molecular systems for digital information processors, optical recording, thermal writing displays, laser printers, infrared photography, or the like. An example of an electrochromic device is shown in FIG. 1. However, it should be understood that this is by way of example only. In other embodiments, the electrochromic device may have different structures or electrical configurations, etc. The electrochromic device also need not be transparent or designed to allow light to pass through; an example of such a device is an electrochromic mirror.

In one set of embodiments, an electrochromic device may comprise a working electrode and a counter electrode, over which a voltage can be applied. The voltage may be used to cause the flow of electrons from the counter electrode to the working electrode, or in the opposite direction (e.g., if a negative voltage is applied). As a non-limiting example, FIG. 1 shows an electrochromic device comprising a working electrode 11 and a counter electrode 15, over which a voltage V (20) can be applied, to cause electrons (e⁻) to flow from the working electrode through the electrochromic layer to the counter electrode.

One or both of these electrodes may be substantially transparent in certain cases, e.g., to allow a substantial amount of light to pass through the electrode, at least in the visible range. For instance, an electrode may allow at least 50%, at least 70%, or at least 90% of the incident visible light to pass through. For instance, an electrode may be made from a substantially transparent material, such as indium tin oxide (ITO), ZnO:F, ZnO:Al, ZnO:Ga, ZnO:B, ZnO:In, In₂O₃:Sn, Cd₂SnO₄, SnO₂:Sb, conjugated polymers (such as PEDOT:PSS), silver nanowires, graphene, or other materials. However, in some embodiments, one or both of the electrodes may be made out of materials that are not substantially transparent, for example, metals such as platinum, gold, silver, or copper, or conductive non-metals such as carbon. In some cases, materials that are not substantially transparent may nonetheless be used, e.g., in embodiments where the electrode is substantially transparent, or where light is allowed to pass through the device; for example, the electrode may be formed as a mesh or other structure containing openings that allows at least some light to pass through. In addition, it should be understood that an electrode need not be substantially transparent in all embodiments, and that the electrodes within a device may have the same or different amounts of light transparency.

In some embodiments, the electrochromic layer is not stable. For example, the electrochromic device may also contain an additive stabilizing it against photostability or weatherability. Additives may include, but are not limited to, light stabilizers, including UV absorbers, quenchers, radical scavengers, peroxide decomposers such as (2-hydroxyphenyl)benzotriazoles, hydroxyphenyl-s-triazines, 2-hydroxybenzophenones, oxalicanilides, hydroxyphenylpyrimidines, salicylic acid derivatives, cyanoacrylates, or other materials with high extinction coefficients, broad absorption bands (e.g., between 290-380 nm), steep absorption curves in the near-UV light range, photochemical stability, good solubility in typical solvents used in electrochromic devices, low volatility, etc. Many such additives are commercially available.

In some embodiments, stabilization of other device components, e.g., within the electrochromic layer, may be used for improvements of the electrode/electrolyte interface, electrochemical stability window, and/or flammability. These may include, but are not limited to, electrolyte additives, electrode passivation additives, such as substituted catechol carbonate, ethylene sulfite, propylene sulfite, fluoroethylene carbonate, vinylene carbonate, N,N′-diethylaminotrimethylsilane, N,N′-diethylamino trimethylsilane, heptamethyldisilazane, ethylene dioxythiophene, prop-1-ene-1,3-sulfone, and the like. Other additives that may be used include, but are not limited to, overcharge protection additives, such as biphenyl, cyclohexylbenzene, xylene, 2,5-ditertbutyl-1,4-dimethoxybenzene, and the like.

In other embodiments, the device may include flame retardant additives, such as halide and phosphorus compounds, including but not limited to, alkyl phosphates, aryl phosphates, mixed alkyl aryl phosphates, alkyl phosphites, alkyl phosphonates, phosphonamidate, phosphazenes, tris(2,2,2-trifluoroethyl) phosphite, tris(2,2,2-trifluoroethyl) phosphate, tris(pentafluorophenyl) phosphine, and bis(2,2,2-trifluoroethyl) methylphosphonate, and the like. For example, one or more additives may be contained within the electrochromic layer.

In some cases, the electrochromic material is present in a separate region that is in direct contact with the working electrode. However, other configurations are possible. For example, there may be one or more other regions (e.g., layers) intervening between the layer containing the electrochromic material and the working electrode, or the electrochromic material may be present as part of the working electrode, instead of being present in a separate region. As an example, in FIG. 1, electrochromic region 12 is shown adjacent to, or as a thin layer deposited on the working electrode. In other cases, the electrochomic material may be in direct contact with the working electrode. In some embodiments, the electrochromic material may be embedded within the working electrode.

In some cases, the electrochromic region may be relatively thin, for example, as a layer or a coating on an electrode. For instance, in some cases, the region may have a cross-sectional thickness of less than 1 mm, less than 500 micrometers, less than 300 micrometers, less than 100 micrometers, less than 50 micrometers, less than 30 micrometer, less than 10 micrometers, less than 5 micrometers, less than 3 micrometers, less than 1 micrometer, less than 500 nm, less than 300 nm, less than 100 nm, less than 50 nm, less than 30 nm, less than 10 nm, or less than 5 nm. Without wishing to be bound by any theory, it is believed that thinner regions may allow for more penetration of ions, e.g., from an electrolyte. However, the electrochromic region may also have sufficient thickness so as to cause a substantial change in light absorbance or transmittance, e.g., when a voltage is applied.

Accordingly, in some cases, the device may contain an electrolyte that can contain ions, such as positive ions, that are able to flow towards the working electrode such that the ions are able to interact or react with the electrochromic materials under the influence of the applied voltage.

For instance, in FIG. 1, electrolyte 13 is shown to be adjacent to electrochromic region 12_containing the electrochromic materials, and when a voltage is applied, positive ions (I⁺) are able to flow from the electrolyte to the electrochromic region. However, as noted above, in other cases, the electrochromic region may not be present as a separate region, and the electrochromic materials may be located in a different region within the electrochromic device, e.g., within the working electrode. Examples of positive ions include, but are not limited to, tetraalkylammonium, alkali metal cations (such as Lie, Na⁺, K⁺, Rb⁺, Cs⁺, Fr⁺, H⁺) from inorganic acids (such as sulfuric acid, nitric acid, hydrochloric acid, etc.) or specialty membranes like Nafion or LiPON cations such as those discussed below.

The electrolyte, in some cases, may contain an organic salt and/or a solvent. The electrolyte may include, for example, ionic liquids, polymer electrolytes, solid-state electrolytes, gel electrolytes, aqueous and nonaqueous electrolytes, or the like. Non-limiting examples of organic salts include tetraalkylammonium salts, such as tetrabutylammonium hexafluorophosphate, tetrabutylammonium acetate, tetrabutylammonium benzoate, tetrabutylammonium bistrifluoromethanesulfonimidate, tetrabutylammonium iodide, tetrabutylammonium perchlorate, tetrabutylammonium tetrafluoroborate, tetrabutylammonium tetraphenylborate, tetraethylammonium hexafluorophosphate, tetraethylammonium acetate, tetraethylammonium benzoate, tetraethylammonium bistrifluoromethanesulfonimidate, tetraethylammonium iodide, tetraethylammonium perchlorate, tetraethylammonium tetrafluoroborate, tetraethylammonium tetraphenylborate, or the like. The organic salt may be used to supply ions, e.g., as discussed above. Non-limiting examples of solvents include, acetonitrile (MeCN), N,N-dimethylformamide (DMF), tetrahydrofuran (THF), dimethylsulfoxide (DMSO), 1,2-dimethoxyethane (DME), dichloromethane (DCM), or propylene carbonate (PC), as well as other amphiprotic (neutral, protogenic, and protophilic) and aprotic (dipolar protophilic, dipolar protophobic, and inert) solvents, or the like.

In some cases, some ions that can interact with the electrochromic material may be stored within an ion-storage region. In some cases, the ion-storage region may be made out of other transparent conductors that are capable of storing charge, such as nickel oxide, vanadium oxide, etc. In certain embodiments, the positive ions from the electrolyte may interact with the electrochromic material and/or the negative ions may go into the ion-storage layer. A non-limiting example of such a region is shown in FIG. 1 as ion-storage region 14. However, it should be understood that such a region is optional, and in certain embodiments, no ion-storage region may be present, e.g., when the counter electrode itself can accommodate the ions.

In addition, in certain embodiments, the electrochromic device may also be contained within a suitable protective media. For example, as is shown in FIG. 1, glass regions 10 and 16 may be used to protect the device. The protective media may be, for example, glass, plastics, polymers, or the like, and in certain embodiments, the protective media may be non-conductive. Examples of other protective media include, but are not limited to, polycarbonate, acrylic, polyvinyl chloride (PVC), polyethylene terephthalate glycol-modified (PETG), cyclic olefin copolymer, liquid silicon rubber, polyethylene, ionomer resin, transparent polypropylene, fluorinated ethylene propylene, styrene methyl methacrylate, styrene acrylonitrile resin, etc.

U.S. Provisional Patent Application Ser. No. 62/927,095, filed Oct. 28, 2020, entitled “Electronic Control of Transmittance of Visible of Near-Infrared Radiation,” by Sheberla, et al. is incorporated herein by reference.

The following examples are intended to illustrate certain embodiments of the present invention, but do not exemplify the full scope of the invention.

### EXAMPLE 1

This example illustrates the spectroscopic profile of 2-(4-nitrobenzoyl)oxazole, before and after reduction, showing a significant decrease in the transmittance of light as is shown in FIG. 2, in accordance with one embodiment of the invention. UV-Vis spectra were recorded on an Avantes spectrophotometer from 230 nm to 1100 nm using matched 1-cm quartz cells and optic fiber cables. All spectra were obtained using a solvent reference blank in a cuvette.

### EXAMPLE 2

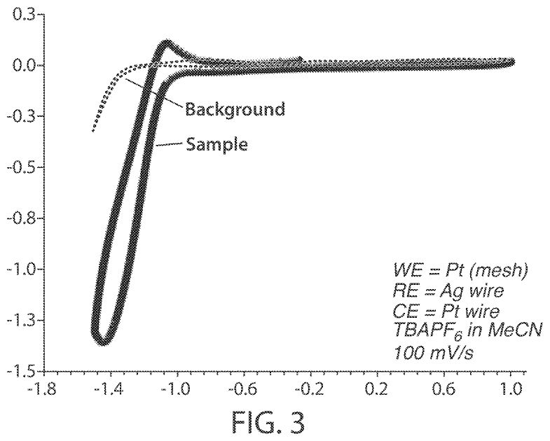

This example illustrates a cyclic voltammetry experiment showing the reduction of 2-(4-nitrobenzoyl)oxazole in acetonitrile and tetrabutylammonium hexafluorophosphate, as is shown in FIG. 3. Cyclic voltammetry measurements were conducted on a potentiostat using transparent conductor on glass or platinum or gold mesh as the working electrode, transparent conductor or platinum or gold mesh as the counter electrode, and 0.25-mm silver wire as the pseudo-reference electrode. A thin film of the nitrobenzoyloxazole was deposited on the working electrode and all three electrodes were immersed in an electrolyte solution. The current was measured as a function of applied potential.

### EXAMPLE 3

The following synthetic routes can be used to prepare certain nitrobenzoyl compounds, as various non-limiting examples:

Based on Yang, et al., “Nickel-Catalyzed Decarboxylative Acylation of Heteroarenes by sp² C—H Functionalization,” Chem.: Eur. J., 20(24):7241, 2014:

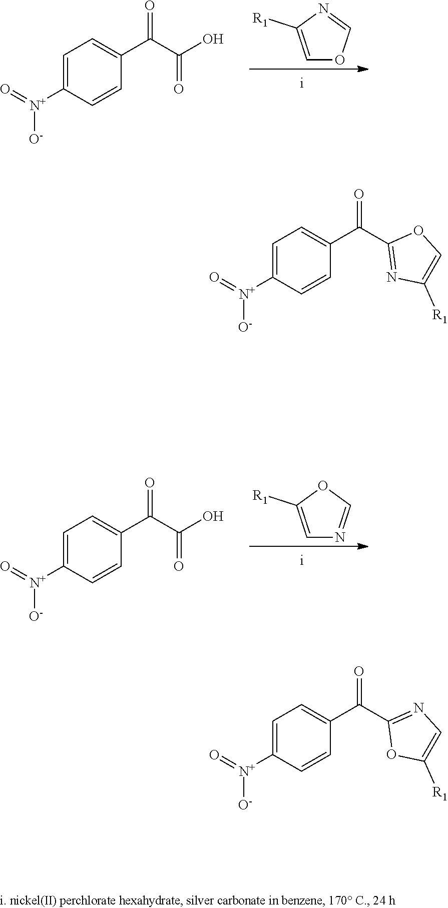

Based on Int. Pat. Apl. Pub. No. WO 2013/050424:

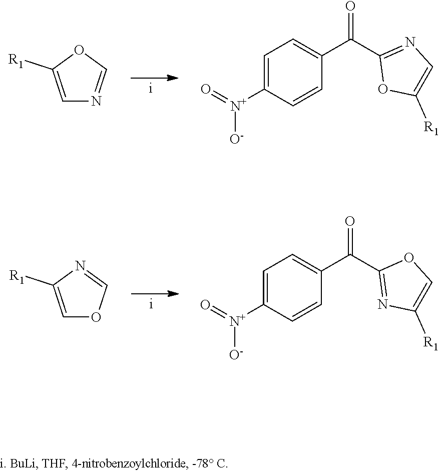

Based on Dolciami, et al., “Binding Mode and Structure-Activity Relationships of ITE as an Aryl Hydrocarbon Receptor (AhR) Agonist,” ChemMedChem, 13(3):270, 2018:

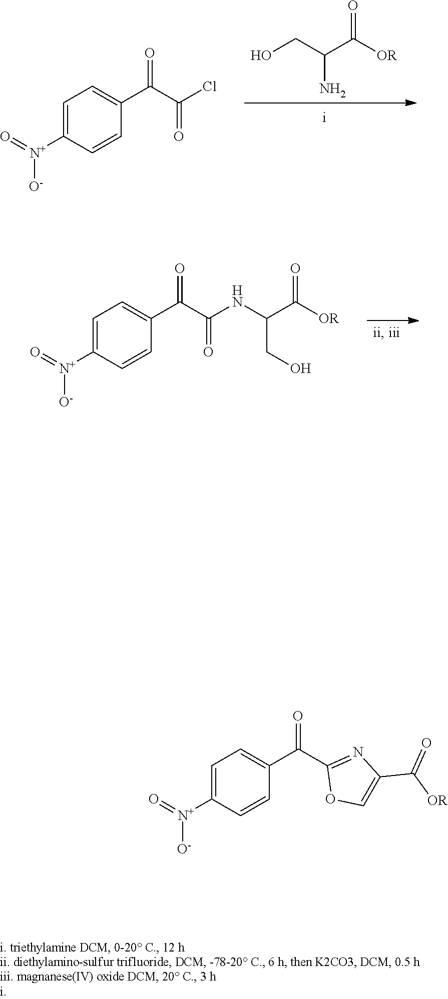

Based on Aranha, et al., “Facile 1,3-diaza-Claisen Rearrangements of Tertiary Allylic Amines Bearing an Electron-Deficient Alkene,” Org. Lett., 11:575, 2009:

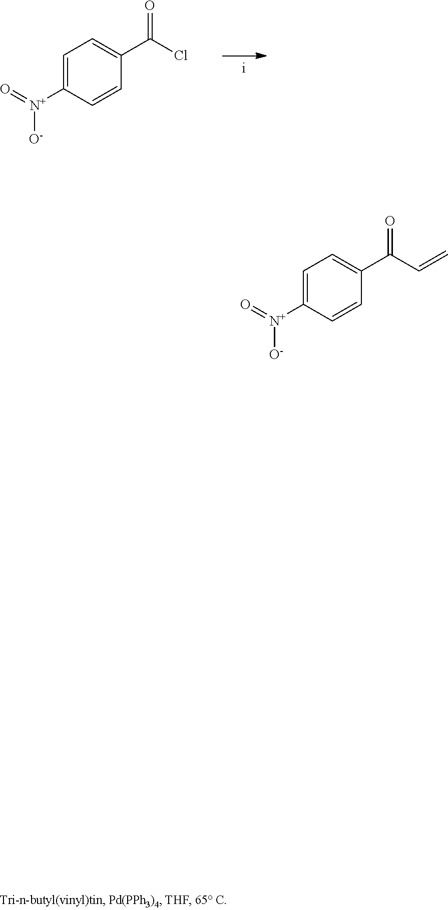

The treatment of 4-nitroacetophenones with anhydrous chloral forms 1-aryl-4,4,4-trichloro-3-hydroxybutan-1-ones by dehydration with sulfuric acid may give 1-aryl-4,4,4-trichlorobut-2-en-1-ones as discussed in Guirado, et al., “First synthesis of 1-aryl-4,4-dichlorobut-3-en-1-ones. The electrochemical reduction of 1-aryl-4,4,4-trichlorobut-2-en-1-ones as a key step,” Tetrahedron, 63(5):1175-1182, 2007. This can used for synthesis in the example listed below.

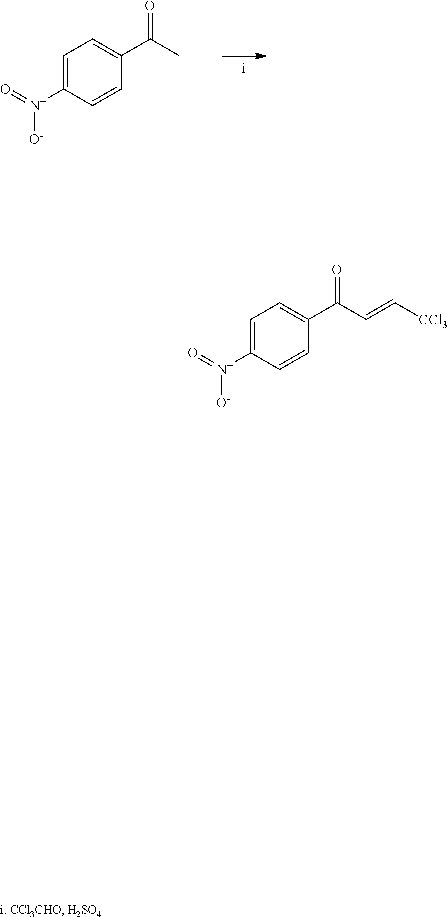

Based on Huang, et al., “A convenient synthesis of 2-acyl benzothiazoles/thiazoles from benzothiazole/thiazole and N,N′-carbonyldiimidazole activated carboxylic acids,” Tetrahedron Lett., 60:1667, 2019:

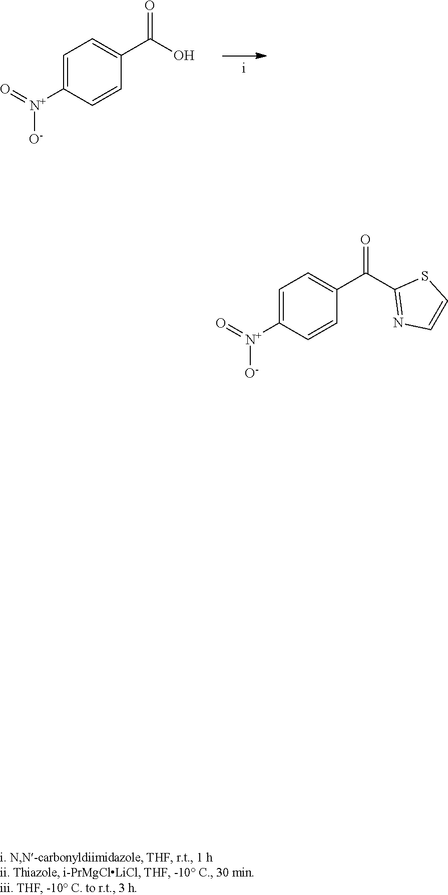 [SMILES: O=C(O)c1ccc([N+](=O)[O-])cc1 ; O=C(c1ccc([N+](=O)[O-])cc1)c1nccs1]

A representative example for substituted nitrobenzoyl compounds, in this case, 2,6-dimethyl-4-nitro-benzoyloxazole, based on Tnt. Pat. Apl. Pub. No WO2014/154727, can be synthesized as shown in the following. Availability of the benzoyl chloride derivative, which in turn comes from a single step reaction from its acid precursor makes this synthetic route a very general way to make a variety of substituted benzoyl compounds, by making suitable substitutions to this reaction.

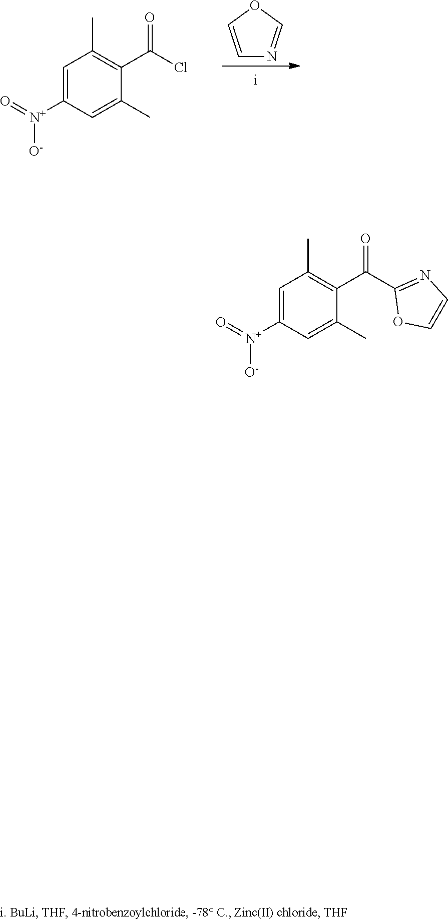 [SMILES: Cc1cc([N+](=O)[O-])cc(C)c1C(=O)Cl ; c1cocn1 ; Cc1cc([N+](=O)[O-])cc(C)c1C(=O)c1ncco1]

Based on Herck, et al., “Covalent Adaptable Networks with Tunable Exchange Rates Based on Reversible Thiol-yne Cross-Linking,” Angew. Chem. Int. Ed., 59(9):3609-3617, 2020:

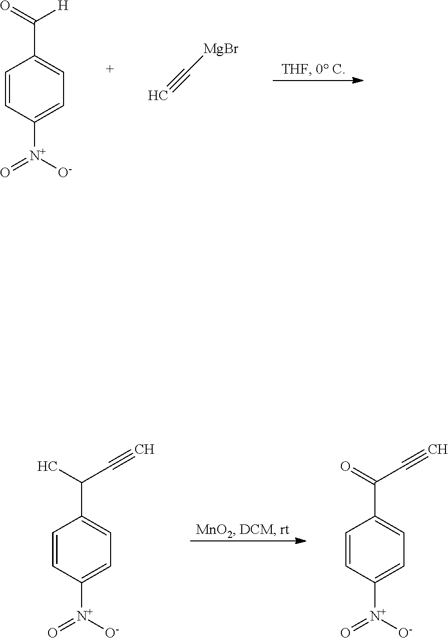

Based on Niesobski, et al., “Sequentially Pd/Cu-Catalyzed Alkynylation-Oxidation Synthesis of 1,2-Diketones and Consecutive One-Pot Generation of Quinoxalines,” Eur. J. Org. Chem., 2019(31-32), 2019:

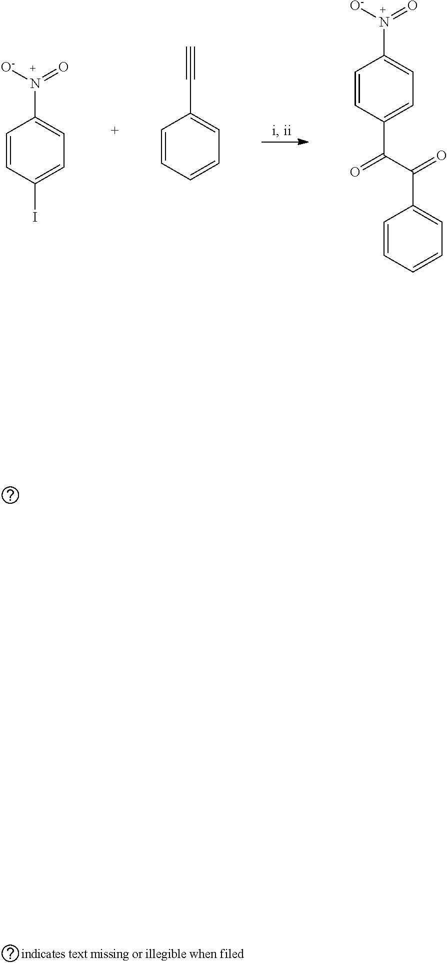

Based on Cui, et al., “A sustainable synthesis of 2-benzoxazyl and 2-benzothiazyl ketones from alkynyl bromides and 2-amino(thio)phenols promoted by a recyclable catalytic system,” Chn. J. Chem., 30(4), 2012:

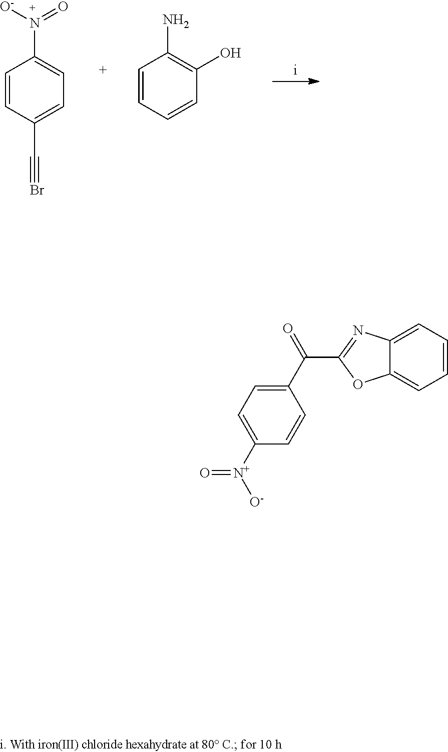

Based on Li, et al., “The C—H Activation/Bidirecting Group Strategy for Selective Direct Synthesis of Diverse 1,1′-Biisoquinolines,” Org. Lett., 22(11), 2020:

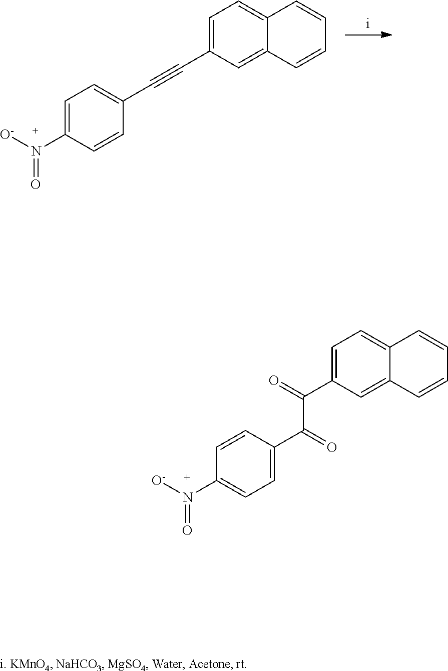

### EXAMPLE 4

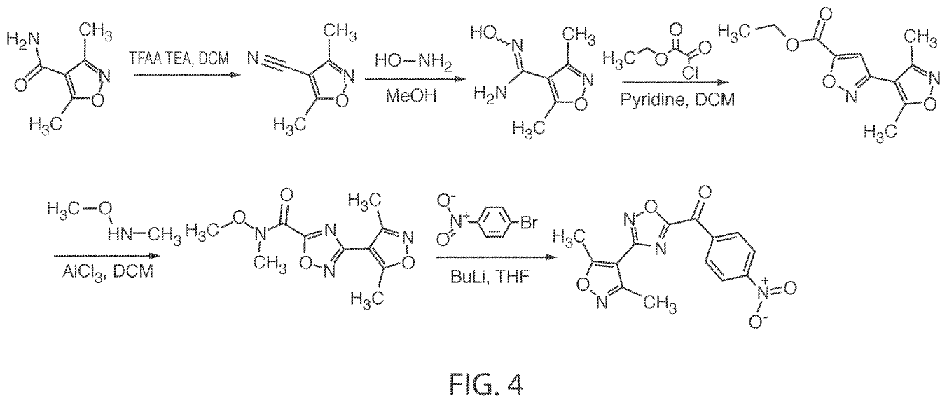

This example illustrates another method of making a nitrobenzoyl compound, in accordance with another embodiment. The reaction scheme in this example has 5 steps, shown in FIG. 4. This procedure is based on (1) Davies, et al., “Targeting conserved water molecules: Design of 4-aryl-5-cyanopyrrolo[2,3-d]pyrimidine Hsp90 inhibitors using fragment-based screening and structure-based optimization,” Bioorg. Med. Chem., 20(22):6770-6789, 2012; (2) Int. Pat. Apl. Pub. No. WO 2009/80663 and Jadhav, et al., “Synthesis, characterization, and antimicrobial activities of clubbed [1,2,4]-oxadiazoles with fluorobenzimidazoles,” J. Heterocycl. Chem., 46(5):980-987, 2009; (3) Int. Pat. Apl. Pub. No. WO 2018/07249; (4) Paterson, et al., “Studies in polypropionate synthesis: High π-face selectivity in syn and anti aldol reactions of chiral boron enolates of lactate-derived ketones,” Tetrahedron Lett., 35(48):9083-9086, 1994; and (5) U.S. Pat. Apl. Pub. No. 2007/0066657.

### EXAMPLE 5

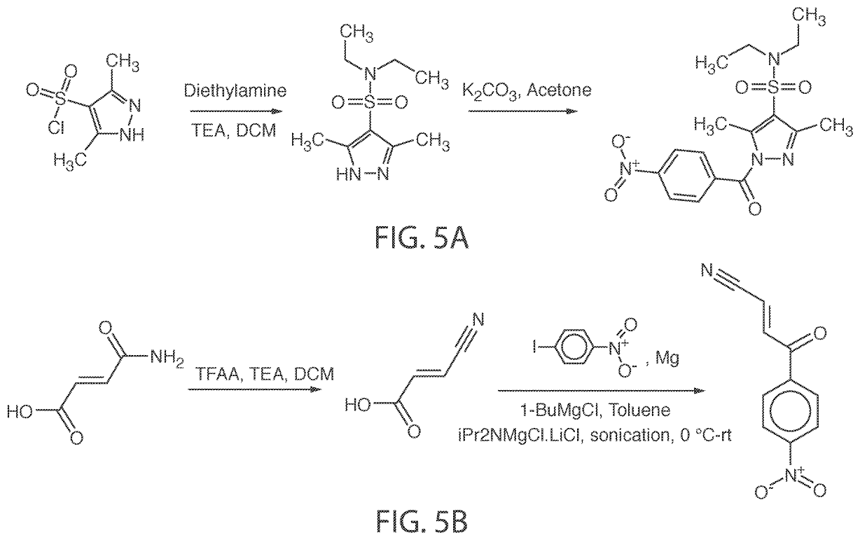

This example illustrates yet another method of making a nitrobenzoyl compound, in accordance with another embodiment. The reaction scheme in this example is shown in FIG. 5.

In the first reaction scheme (FIG. 5A), the first reaction of sulfonylchloride with amine. See, e.g., Int. Pat. Apl. Pub. No. WO 2017/66742. This is followed by N-alkylation in presence of a base. See, e.g., Soliman, et al., “Antidiabetic activity of some 1-substituted 3,5-dimethylpyrazoles,” J. Med. Chem., 26(11):1659-1663, 1983.

In the second reaction scheme (FIG. 5B), the first reaction is the conversion of amides to nitrile using trifluoroacetic anhydride (TFAA). See, e.g., Wong, et al., “Batch Versus Flow Lithiation-Substitution of 1,3,4-Oxadiazoles: Exploitation of Unstable Intermediates Using Flow Chemistry,” Chem. Eur. J., 25(53):12439-12445, 2019, or Nagy, et al., “New Preparative Route to Hetaryldienes and Azadienes,” Heterocycles, 64(10):2287-2307, 2004. This is followed by the direct conversion of carboxylic acids to ketones. See, e.g., Colas, et al., “i-Pr₂NMgCl·LiCl Enables the Synthesis of Ketones by Direct Addition of Grignard Reagents to Carboxylate Anions,” Org. Lett., 21(19):7908-7913, 2019.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain, using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When the word “about” is used herein in reference to a number, it should be understood that still another embodiment of the invention includes that number not modified by the presence of the word “about.”

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A method, comprising:
applying voltage to an electrochromic material comprising a compound as recited in claim 125 to cause the electrochromic material to exhibit a change in light transmittance.

2-42. (canceled)

43. An electrochromic device, comprising:
an electrochromic region comprising a compound as recited in claim 125; and
a voltage source able to apply voltage to the electrochromic region.

44-70. (canceled)

71. The electrochromic device of claim 43, wherein the electrochromic region exhibits a change in light transmittance when a voltage is applied to the electrochromic region by the voltage source.

72. The electrochromic device of claim 43, wherein the electrochromic region exhibits a change in visible light transmittance.

73. The electrochromic device of claim 43, wherein the electrochromic region exhibits a change in infrared light transmittance.

74. The electrochromic device of claim 43, wherein the electrochromic region exhibits a decrease in light transmittance of at least 20% when a voltage is applied.

75. The electrochromic device of claim 43, wherein the electrochromic region exhibits a decrease in light transmittance of at least 40% when a voltage is applied.

76. The electrochromic device of claim 43, further comprising a working electrode and a counter electrode for applying the voltage to the substrate.

77-78. (canceled)

79. The electrochromic device of claim 76, wherein the electrochromic region is adjacent to the working electrode.

80. The electrochromic device of claim 76, wherein the working electrode comprises the electrochromic region.

81. The electrochromic device of claim 76, further comprising an electrolyte positioned between the working electrode and the counter electrode, wherein the electrolyte comprises ions able to react with the compound to exhibit a change in light transmittance.

82-86. (canceled)

87. An electrochromic device, comprising:
a working electrode;
a counter electrode;
an electrochromic region comprising a compound as recited in claim 125, positioned adjacent to the working electrode; and
an electrolyte comprising an organic salt and a solvent, positioned adjacent to the electrochromic region.

88-122. (canceled)

123. An electrochromic device, comprising:
a working electrode;
a counter electrode;
a voltage source electrically connecting the working electrode and the counter electrode;
an electrochromic region comprising a compound as recited in claim 125; and
an electrolyte comprising an organic salt and a solvent, positioned to cause ions from the organic salt to enter the electrochromic region when a voltage is applied by the voltage source.

124. A method, comprising:
applying voltage to an electrochromic material comprising a compound as recited in claim 126 to cause the electrochromic material to exhibit a change in light transmittance.

125. A compound selected from the group consisting of the following compounds, each identified by a first hash block of an InChIKey representation of the compound:
ALLWAOSHMBUSCG, ANXJCOOLVBUNGC, ATDIBDUBFUULMN, ATXBYXPOUBWGHS, BFCVRVKHVUSCDV, BFTZIIDFRHNXMH, BQUJHULPLWGXOR, BTKLFRTYJPEJJV, CFSIHLPYLRSZND, CISOONJPSVTMQY, CJWGKFBZERHWSU, CKBXXPLJRZKNBZ, CLUOWPXRGXTPAP, CLZNECLDGVRQDO, CSKUDVYHCDOHPO, CUIZUILBFZEWKW, CVVFXZOGKDDCLB, CWCIEEKNDVRBIB, DFTDWRPGBRJUGT, DGFFFXLJBKUUSY, DHZJXWFGYZAUGQ, DLYLCCAYBAXGIV, DNWHZADRGVNWLT, DOGFYCUNNPFFHS, DOHIUYSVWJFUEB, DPVHSBXNLONAGP, DTIZLTGKXWBLGU, DXSFEOPOTUNUMO, FBSXXYPHBYWBNJ, FDTISEJWMLFUTE, FFWNAHKRLGYITG, FMEVKSODUUEHQZ, FOYMFTCJUJZPMY, FQCGPBFYVGXFLE, FQTKKRXSWGNDRP, FRBHHVCOZRPDNM, FSLAMAAJAOBRFO, FTENHAOQXAWXRY, FUOCNALBJNFCDV, GEMFSLGMUJZKIM, GQCCGBNVDDIECM, GQZMJHCVCLKAFJ, GTHQONOMXXUAIQ, HCGUMPIRUBNLTL, HCYWBRAXICYAAY, HGHDROGAWZHXHU, HHVKBHNOTDWWCE, HIAPIDNDGAXANE, HIFFPLXLAOJWKW, HJHSQWYKEHATOI, HKOBUDAQQYMHFJ, HNPZSAZMXUGEHV, HOXHDFIFUUCBRO, HQOZVNBWYRGKHT, HRVNBUVDWWJGNH, HVSDMYGTBZEMAO, HWEYGIPITMKNKX, IFHLQKJXZQZPCK, IFNLHKUCDOEGDG, IFXIEZOJDXODRB, IGOQZFQHMOOVPJ, IKITXNGXHRYAPC, IKRRWMLPKPREBB, IPJVITGXJLPVQW, IWJTZHCKZQJTOZ, IWZBDCZQSPYOAC, JHBBZJIDQPQLFN, JJIUUGUVFIYHSA, JNJDRAIAVKACAP, JODSTBULQMGAAI, JWPFVFACMAVKFR, JXDSBZUFCHGVKF, JYZOMERLVYWRRR, KHPYGPOJAPXYPX, KIXAZOMAQCNPRU, KJIBUICULJHDBX, KKGCRDFFUMWKIF, KMQVXEMBOKKZNO, KONRIEMWPOQRRX, LBGIRCOKXRCQJR, LCXOVVPVKAXNLO, LFIDXGCBAQQTNX, LFQGCGXMMGBNCP, LSEPQTKAKRATOD, LSGHWUSRGHSPTB, LTQITSPOILMBLL, LXGAOSBSSDEKGU, LZDZNMZFMCDENN, MAQMWZXVVCMDAR, MEIUQXRWIPDZCF, MLIOHAJOVLXNTQ, MOFOPDUBGJCWOK, MYPUTLNIQSRWTG, NCAPCIGOEOKRTK, NCVLSXIFCXWBON, NDCQKBWZVUIVNF, NEEAVCLSDNCPGA, NNMBHXHRSTXKIP, NOHLKFAGVTZKAV, NTQGLAQKXZOTAU, NUVXYPUEUJUHRJ, NVJNEPNFGITCFK, NYJBAAADZNLEOO, OEJUOQYHZBDERD, OFAOINIMTBXHRC, OGHLZQNNCSTFHG, ONZWCAHSYZPUFE, OOHMNTJGGZZPPY, OQCPMYIDZIXNEB, PAACALUYKFODHE, PAODJXVDQFZRJH, PSQYJKBJVWKQQF, PTQHYVGEIKBKRK, PYCIVHJZSSEALF, QDISDVFPDXYPAE, QFNMQYZZYGZYQK, QJIVYHVZZOKKCT, QODAIMMRRLDBHV, QPQTWLWYLKNLKH, QPWZMHZYYNSIQC, QSLLQPDUKXABJK, QULQQZMXLMQWAM, QWYBFIMUTLGVLH, QZNYZBQRHMUISC, REAKBOKAGPKLOT, RKTWQWAQEUUXKS, RKWWEZSEONJEEZ, RNFWQXYXMKHHTI, RRJYHLUEVJBVIR, RRTSRPMGAQAXRY, RWFBBKNTRLCNOR, SRMXGFPDJXPYSX, STILHLHJNNOKQX, SVEJZQATPYNHRZ, SZRACDIPBYGTAF, TXOKBUVWTJPKCJ, UCURZIIQALXDJF, UQRPDKNXWCACOD, URAKZOZXVIQVNV, UXPKTORKSCQDRB, UYWIMHORAHKOHF, VCRZQQIVAZRHQL, VKYIKSLOFJYZKM, VNGXCTBWDSCQBH, VSFJUFJGUCMFGX, VTYTYZWERWWQAC, WBSQWAUDNFZVRO, WDIVEVPYHBKUKW, WGZBZTXFZCMZDI, WHHFABDZOJYRIY, WMESLTLNWRZXIX, WPQISOPBMPXZSO, WRPJEUMIIRURTI, WSAIJJSIPFTCBM, WWSXTJKNGBMBGX, XLUQSHGOGMNSIL, XOIQMYZUIYUZGH, XRASQPAHNHZDGF, XTWLNCAHPVTNTH, XUABSJAPHVAKHG, XZSSXGUYNGENFA, YDTSFOBAODKAON, YFDJFPAQXSGXTI, YKSLNRDPOBUZPH, YRZQMKPKHNMKLM, YUPOVDCLRSVNFD, ZAGDGEXATRGHGL, ZFPGIFZGPASVIJ, ZGLMYHSGIKBSOJ, ZIWQFPMIZMHGKL, ZNSOUJFLMUUPFZ, ZOJHEYOKFWFWJL, and ZSNAKPLZSNZBCX.

126. A compound selected from the group consisting of the following compounds, each identified by a first hash block of an InChIKey representation of the compound:
ALLWAOSHMBUSCG, ATDIBDUBFUULMN, ATXBYXPOUBWGHS, BFCVRVKHVUSCDV, BQUJHULPLWGXOR, BTKLFRTYJPEJJV, CISOONJPSVTMQY, CUIZUILBFZEWKW, CVVFXZOGKDDCLB, DGFFFXLJBKUUSY, DHZJXWFGYZAUGQ, DLYLCCAYBAXGIV, DNWHZADRGVNWLT, DOHIUYSVWJFUEB, DPVHSBXNLONAGP, DXSFEOPOTUNUMO, FDTISEJWMLFUTE, FFWNAHKRLGYITG, FQCGPBFYVGXFLE, FRBHHVCOZRPDNM, FSLAMAAJAOBRFO, FTENHAOQXAWXRY, GEMFSLGMUJZKIM, GQCCGBNVDDIECM, GQZMJHCVCLKAFJ, GTHQONOMXXUAIQ, HCGUMPIRUBNLTL, HCYWBRAXICYAAY, HHVKBHNOTDWWCE, HIFFPLXLAOJWKW, HQOZVNBWYRGKHT, HWEYGIPITMKNKX, IFHLQKJXZQZPCK, IFXIEZOJDXODRB, IGOQZFQHMOOVPJ, IKITXNGXHRYAPC, IPJVITGXJLPVQW, IWJTZHCKZQJTOZ, IWZBDCZQSPYOAC, JJIUUGUVFIYHSA, JNJDRAIAVKACAP, JWPFVFACMAVKFR, JXDSBZUFCHGVKF, JYZOMERLVYWRRR, KHPYGPOJAPXYPX, KKGCRDFFUMWKIF, KONRIEMWPOQRRX, LBGIRCOKXRCQJR, LCXOVVPVKAXNLO, LFQGCGXMMGBNCP, LSGHWUSRGHSPTB, LTQITSPOILMBLL, MAQMWZXVVCMDAR, MEIUQXRWIPDZCF, NCVLSXIFCXWBON, NDCQKBWZVUIVNF, NOHLKFAGVTZKAV, NTQGLAQKXZOTAU, OFAOINIMTBXHRC, ONZWCAHSYZPUFE, OQCPMYIDZIXNEB, PAACALUYKFODHE, PSQYJKBJVWKQQF, PYCIVHJZSSEALF, QFNMQYZZYGZYQK, QPQTWLWYLKNLKH, QSLLQPDUKXABJK, QZNYZBQRHMUISC, REAKBOKAGPKLOT, RKTWQWAQEUUXKS, RKWWEZSEONJEEZ, RRJYHLUEVJBVIR, RRTSRPMGAQAXRY, SRMXGFPDJXPYSX, STILHLHJNNOKQX, SZRACDIPBYGTAF, UQRPDKNXWCACOD, URAKZOZXVIQVNV, UXPKTORKSCQDRB, UYWIMHORAHKOHF, VNGXCTBWDSCQBH, VSFJUFJGUCMFGX, WDIVEVPYHBKUKW, WGZBZTXFZCMZDI, WPQISOPBMPXZSO, WRPJEUMIIRURTI, WSAIJJSIPFTCBM, XLUQSHGOGMNSIL, XOIQMYZUIYUZGH, XTWLNCAHPVTNTH, XUABSJAPHVAKHG, XZSSXGUYNGENFA, YDTSFOBAODKAON, YFDJFPAQXSGXTI, YRZQMKPKHNMKLM, ZAGDGEXATRGHGL, ZGLMYHSGIKBSOJ, and ZSNAKPLZSNZBCX.

127. An electrochromic device, comprising:
an electrochromic region comprising a compound as recited in claim 126; and
a voltage source able to apply voltage to the electrochromic region.

128. An electrochromic device, comprising:
a working electrode;
a counter electrode;
an electrochromic region comprising a compound as recited in claim 126, positioned adjacent to the working electrode; and
an electrolyte comprising an organic salt and a solvent, positioned adjacent to the electrochromic region.

129. An electrochromic device, comprising:
a working electrode;
a counter electrode;
a voltage source electrically connecting the working electrode and the counter electrode;
an electrochromic region comprising a compound as recited in claim 126; and
an electrolyte comprising an organic salt and a solvent, positioned to cause ions from the organic salt to enter the electrochromic region when a voltage is applied by the voltage source.
